(19) United States
(12) Patent Application Publication
(10) Pub. No.: US 2025/0294424 A1
(43) Pub. Date: Sep. 18, 2025

(54) Prediction-Based Mobility Management

(71) Applicant: QUALCOMM Incorporated, San Diego, CA (US)

(72) Inventors: Rajeev KUMAR, San Diego, CA (US); Punyaslok PURKAYASTHA, San Diego, CA (US); Shankar KRISHNAN, San Diego, CA (US); Aziz GHOLMIEH, Del Mar, CA (US); Ozcan OZTURK, San Diego, CA (US)

(21) Appl. No.: 18/604,158

(22) Filed: Mar. 13, 2024

(51) Int. Cl. H04W 36/32

(52) U.S. Cl. CPC H04W 36/32

(57) ABSTRACT

Certain aspects of the present disclosure provide techniques for prediction-based mobility management. An example method for wireless communications includes obtaining a first indication of a first prediction of one or more candidate communication links for a communication link modification, and a second indication of a validity time associated with the first prediction, wherein the validity time indicates a time period during which the first prediction is valid; and communicating with a network entity based at least in part on the first prediction during the validity time.

### FIELD OF THE DISCLOSURE

Aspects of the present disclosure relate to wireless communications, and more particularly, to techniques for mobility management.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Mobility management is a scheme employed to ensure service-continuity for a user equipment (UE) through handovers and/or beam switching during UE mobility, for example, as the UE moves across different coverage areas of a radio access network. In some cases, during a handover, the selection of a target cell and/or candidate cell is performed based on radio measurements without considering other information (such as a past UE mobility pattern or traffic). Thus, it can be challenging to perform a handover without a failure as trial and error is effectively used to find a suitable target cell.

Aspects described herein provide various schemes for configuring a UE based on a UE mobility prediction to enhance the handover performance. The techniques for mobility management described herein may enable improved wireless communication performance, such as reduced latencies, packet losses, handover failures, premature handovers, and/or ping-ponging between network entities.

One aspect provides a method for wireless communications by an apparatus. The method includes obtaining a first indication of a first prediction of one or more candidate communication links for a communication link modification, and a second indication of a validity time associated with the first prediction, wherein the validity time indicates a time period during which the first prediction is valid; and communicating with a network entity based at least in part on the first prediction during the validity time.

Another aspect provides a method for wireless communications by an apparatus. The method includes sending a first indication of a first prediction of one or more candidate communication links for a communication link modification, and a second indication of a validity time associated with the first prediction, wherein the validity time indicates a time period during which the first prediction is valid; and communicating with a user equipment (UE) based at least in part on the first prediction during the validity time.

Another aspect provides a method for wireless communications by an apparatus. The method includes obtaining a configuration that indicates one or more criteria that trigger a communication link modification based at least in part on a first prediction of one or more candidate communication links; obtaining an indication of the first prediction; and performing the communication link modification when the one or more criteria are satisfied.

Another aspect provides a method for wireless communications by an apparatus. The method includes sending a configuration that indicates one or more criteria that trigger a communication link modification based at least in part on a first prediction of one or more candidate communication links; sending an indication of the first prediction; and performing the communication link modification when the one or more criteria are satisfied.

Another aspect provides a method for wireless communications by an apparatus. The method includes obtaining an indication of a first prediction of one or more candidate communication links for a communication link modification; performing the communication link modification for a target communication link based on the first prediction; and sending feedback associated with the communication link modification, wherein the feedback indicates the target communication link is based on the first prediction.

Another aspect provides a method for wireless communications by an apparatus. The method includes sending an indication of a first prediction of one or more candidate communication links for a communication link modification; performing the communication link modification for a target communication link based on the first prediction; and obtaining feedback associated with the communication link modification, wherein the feedback indicates the target communication link is based on the first prediction.

Another aspect provides a method for wireless communications by an apparatus. The method includes obtaining an indication of a prediction of one or more communication links for communication link modification and a configuration for communications via at least one communication link of the one or more communication links, wherein the configuration indicates a first set of criteria that trigger application of the configuration and indicates a second set of criteria for selection of one or more parameters of the configuration; and communicating via the at least one communication link based on the configuration.

Another aspect provides a method for wireless communications by an apparatus. The method includes sending an indication of a prediction of one or more communication links and a configuration for communications via at least one communication link of the one or more communication links, wherein the configuration indicates a first set of criteria that trigger application of the configuration and indicates a second set of criteria for selection of one or more parameters of the configuration; and communicating via the at least one communication link based on the configuration.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 illustrates an example artificial intelligence (AI) architecture that may be used for AI-enhanced wireless communications.

FIG. 6 illustrates an example AI architecture of a first wireless device that is in communication with a second wireless device.

FIG. 7 illustrates an example artificial neural network.

FIG. 8 depicts an example of UE mobility in a wireless communications network.

FIG. 9 depicts a process flow for prediction-based mobility management.

FIG. 10 depicts a method for wireless communications.

FIG. 11 depicts another method for wireless communications.

FIG. 12 depicts another method for wireless communications.

FIG. 13 depicts another method for wireless communications.

FIG. 14 depicts another method for wireless communications.

FIG. 15 depicts another method for wireless communications.

FIG. 16 depicts another method for wireless communications.

FIG. 17 depicts another method for wireless communications.

FIG. 18 depicts aspects of an example communications device.

FIG. 19 depicts aspects of an example communications device.

### DETAILED DESCRIPTION

Aspects of the present disclosure provide apparatuses, methods, processing systems, and computer-readable mediums for prediction-based mobility management.

Certain wireless communications systems (e.g., 5G New Radio (NR) system and/or any future wireless communications system) may employ artificial intelligence (AI) to perform various operations, such as channel state feedback (CSF) estimation, CSF encoding/decoding, beam management, device positioning, user equipment (UE) mobility management, etc. UE mobility may involve a UE moving from one position to another position and encountering various communication links (e.g., beam(s), cell(s), and/or cell group(s)) across a radio access network (RAN). For UE mobility prediction, a machine learning (ML) model may be used to predict a UE trajectory and/or handover targets (e.g., beam(s), cell(s), and/or cell group(s)).

Technical problems for ML-based UE mobility prediction may include, for example, employing effective UE configurations based on a UE mobility prediction to improve handover performance. For certain wireless communications systems (e.g., 5G NR systems and/or any future wireless communications systems), mobility management is a scheme employed to ensure service-continuity of a UE through handovers and/or beam switching during UE mobility, for example, as the UE moves across different coverage areas of a RAN. As the coverage area of a single network entity decreases, such as for high-frequency communications (e.g., for mmWave communications), the frequency for UE to handover between network entities becomes high, especially for a high-mobility UE (e.g., a UE traveling in a vehicle). In addition, for applications (e.g., extended reality and/or cloud gaming) characterized with stringent performance specifications (e.g., quality of service (QoS) parameters such as reliability, latency, etc.), the quality of experience may be sensitive to the handover performance, such as unsuccessful handovers. An unsuccessful handover can cause packet losses and/or extra delay during the mobility period, which can cause QoS specifications to not be met for packet-drop-intolerant and low-latency applications. In some cases, during a handover, the selection of the target cell and/or candidate cell(s) is performed based on the radio measurements without considering other information (such as a past UE mobility pattern or traffic). Thus, it can be challenging to perform a handover procedure without a failure.

Aspects described herein may overcome the aforementioned technical problem(s) by providing various schemes for configuring a UE based on a UE mobility prediction. In certain aspects, the UE may be configured to perform certain mobility operations based on a UE mobility prediction (e.g., handover target(s) and/or UE trajectory). The mobility operations may include, for example, a handover, a beam switch, serving cell change or addition, etc. Such prediction-based configurations for mobility operations may be referred to herein as a mobility configuration. In certain aspects, a UE may be configured (e.g., via a pre-configuration and/or signaling) with a validity time associated with a UE mobility prediction and/or a mobility configuration that depends on the UE mobility prediction. The validity time may define a time period during which the UE mobility prediction and/or the mobility configuration is valid. In certain aspects, the UE may be configured with certain criteria (e.g., a probability of encountering a target or candidate cell or beam) that triggers application of a mobility configuration that depends on the UE mobility prediction. In certain aspects, the UE may be configured to send, to a network entity, feedback associated with a UE mobility prediction. In certain aspects, a UE may be configured with certain condition-based configurations (e.g., for radio link monitoring (RLM), beam failure detection (BFD), random access communications, etc.) and/or certain criteria that trigger application of the configurations. A condition-based configuration may have certain conditions for selection of certain parameters, such as selection of radio measurement periodicities based on a UE velocity or time interval. The condition-based configurations may be formed based UE mobility prediction(s).

Certain techniques for mobility management based on mobility prediction(s) described herein may provide various beneficial technical effects and/or advantages. The techniques for mobility management may enable improved wireless communication performance, such as reduced latencies, packet losses, handover failures, premature handovers, and/or ping-ponging between network entities. The improved wireless communication performance may be attributable to the enhanced mobility performance enabled by the various configurations described herein that depend on a UE mobility prediction. For example, a validity time associated with a UE mobility prediction may ensure that the prediction is accurate and/or reliable while the UE is performing a mobility operation, such as a handover. The feedback discussed above may enable a network entity to retrain or reconfigure an ML model used for mobility prediction. The criteria for a mobility configuration discussed above may enable performance of a mobility operation with reduced latencies, packet losses, handover failures, premature handovers, and/or ping-ponging between network entities. The condition-based configurations discussed above may enable improved wireless communications, such as reduced power consumption for radio measurements at a UE, reduced latencies, and/or increased throughput.

The term “beam” may be used in the present disclosure in various contexts. Beam may be used to mean a set of gains and/or phases (e.g., precoding weights or co-phasing weights) applied to antenna elements in (or associated with) a wireless communication device for transmission or reception. The term “beam” may also refer to an antenna or radiation pattern of a signal transmitted while applying the gains and/or phases to the antenna elements. Other references to beam may include one or more properties or parameters associated with the antenna (or radiation) pattern, such as an angle of arrival (AoA), an angle of departure (AoD), a gain, a phase, a directivity, a beam width, a beam direction (with respect to a plane of reference) in terms of azimuth and/or elevation, a peak-to-side-lobe ratio, and/or an antenna (or precoding) port associated with the antenna (radiation) pattern. The term “beam” may also refer to an associated number and/or configuration of antenna elements (e.g., a uniform linear array, a uniform rectangular array, or other uniform array).

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

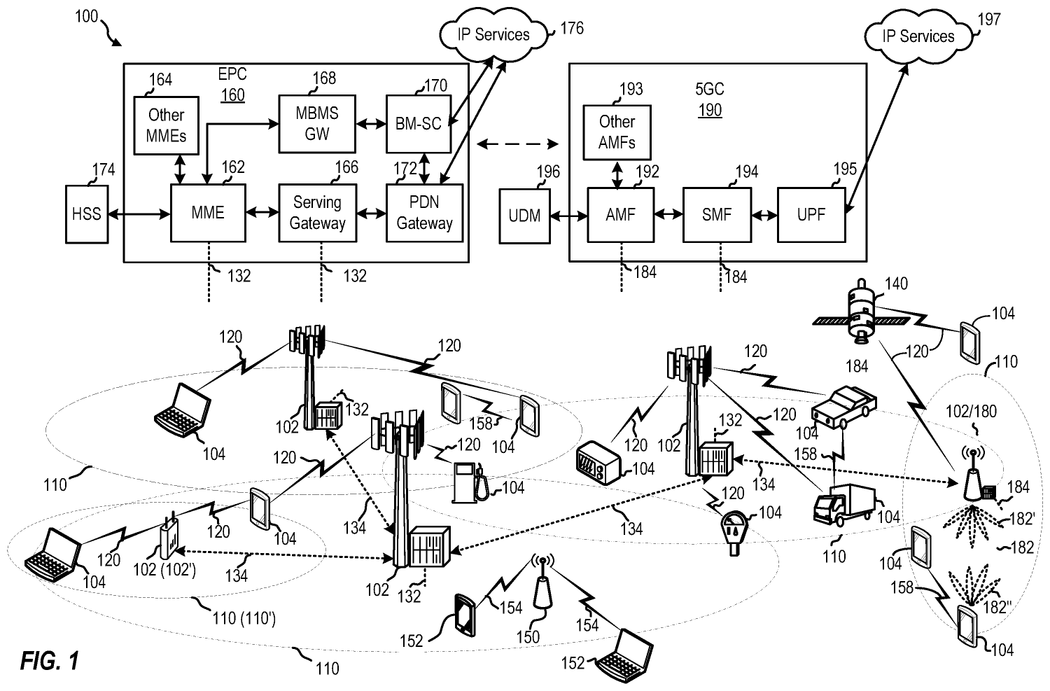

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

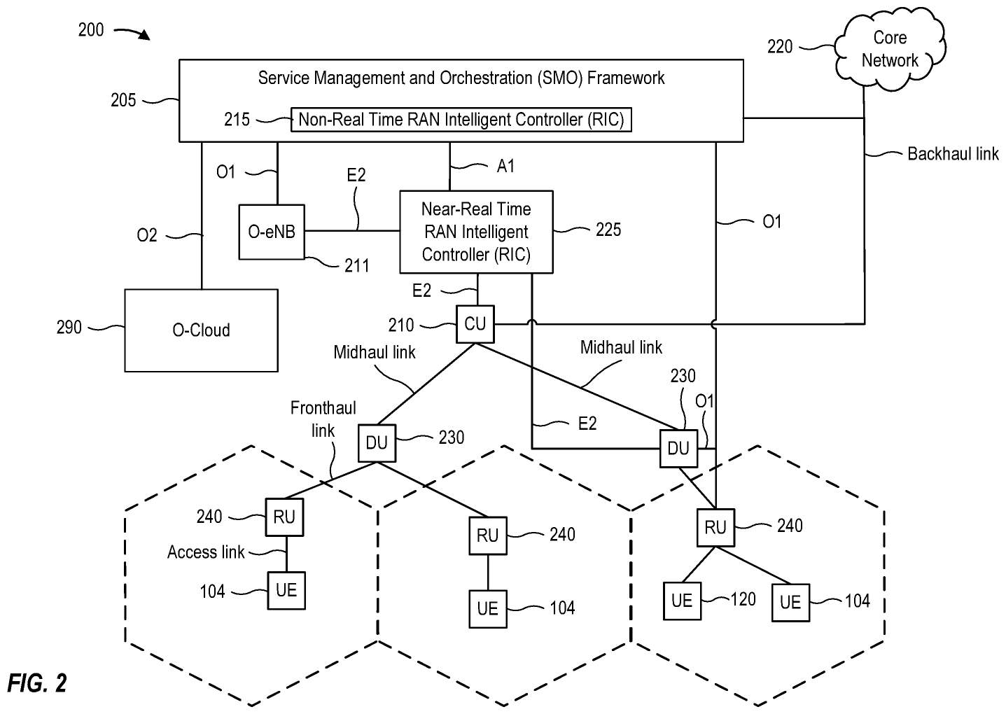

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an AI interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as AI policies).

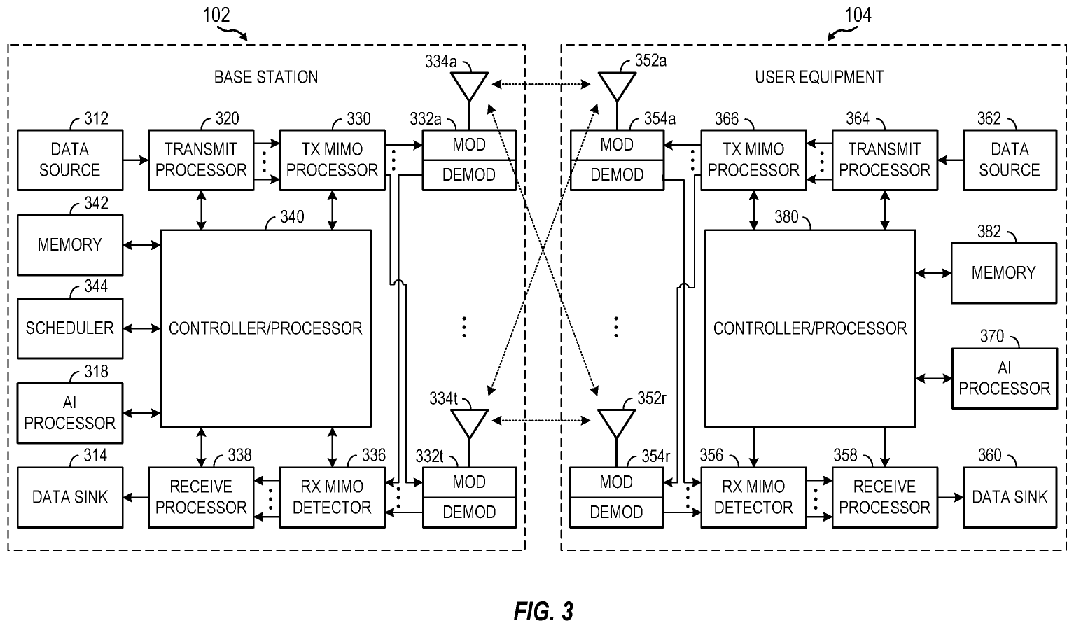

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

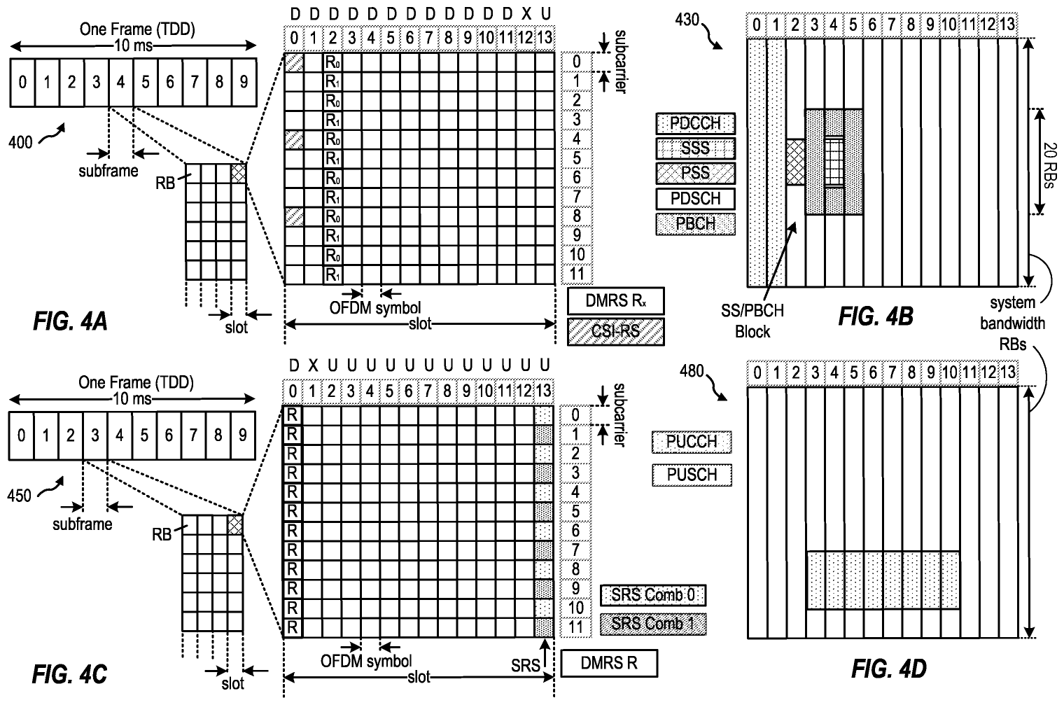

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Artificial Intelligence for Wireless Communications

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

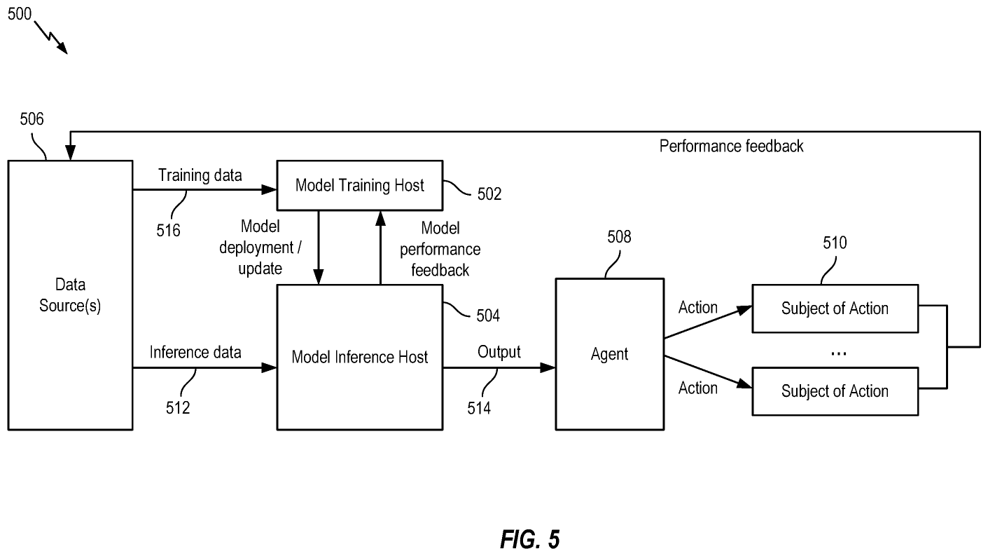

FIG. 5 is a diagram illustrating an example AI architecture 500 that may be used for AI-enhanced wireless communications. As illustrated, the architecture 500 includes multiple logical entities, such as a model training host 502, a model inference host 504, data source(s) 506, and an agent 508. The AI architecture may be used in any of various use cases for wireless communications, such as those listed above.

The model inference host 504, in the architecture 500, is configured to run an ML model based on inference data 512 provided by data source(s) 506. The model inference host 504 may produce an output 514 (e.g., a prediction or inference, such as a discrete or continuous value) based on the inference data 512, that is then provided as input to the agent 508.

The agent 508 may be an element or an entity of a wireless communication system including, for example, a radio access network (RAN), a wireless local area network, a device-to-device (D2D) communications system, etc. As an example, the agent 508 may be a user equipment (UE), a base station or any disaggregated network entity thereof including a centralized unit (CU), a distributed unit (DU), and/or a radio unit (RU)), an access point, a wireless station, a RAN intelligent controller (RIC) in a cloud-based RAN, among some examples. Additionally, the type of agent 508 may also depend on the type of tasks performed by the model inference host 504, the type of inference data 512 provided to model inference host 504, and/or the type of output 514 produced by model inference host 504.

For example, if output 514 from the model inference host 504 is associated with beam management, the agent 508 may be or include a UE, a DU, or an RU. As another example, if output 514 from model inference host 504 is associated with transmission and/or reception scheduling, the agent 508 may be a CU or a DU.

After the agent 508 receives output 514 from the model inference host 504, agent 508 may determine whether to act based on the output. For example, if agent 508 is a DU or an RU and the output from model inference host 504 is associated with UE mobility, the agent 508 may determine whether to change or modify a serving cell based on the output 514. If the agent 508 determines to act based on the output 514, agent 508 may indicate the action to at least one subject of the action 510. For example, if the agent 508 determines to trigger a handover from a source cell to a target cell or candidate cell for a communication between the agent 508 and the subject of action 510 (e.g., a UE), the agent 508 may send a handover indication to the subject of action 510 (e.g., a UE). As another example, the agent 508 may be a UE, the output 514 from model inference host 504 may be one or more predicted neighbor cells for a handover. For example, the model inference host 504 may predict neighbor cells for a handover based on a trajectory of the UE. Based on the predicted neighbor cells, the agent 508, such as the UE, may send, to the subject of action 510, such as a BS, a request to perform a handover to at least one of the predicted neighbor cells. In some cases, the agent 508 and the subject of action 510 are the same entity.

The data sources 506 may be configured for collecting data that is used as training data 516 for training an ML model, or as inference data 512 for feeding an ML model inference operation. In particular, the data sources 506 may collect data from any of various entities (e.g., the UE and/or the BS), which may include the subject of action 510, and provide the collected data to a model training host 502 for ML model training. For example, after a subject of action 510 (e.g., a UE) receives a beam configuration from agent 508, the subject of action 510 may provide performance feedback associated with the beam configuration to the data sources 506, where the performance feedback may be used by the model training host 502 for monitoring and/or evaluating the ML model performance, such as whether the output 514, provided to agent 508, is accurate. In some examples, if the output 514 provided to agent 508 is inaccurate (or the accuracy is below an accuracy threshold), the model training host 502 may determine to modify or retrain the ML model used by model inference host 504, such as via an ML model deployment/update.

In certain aspects, the model training host 502 may be deployed at or with the same or a different entity than that in which the model inference host 504 is deployed. For example, in order to offload model training processing, which can impact the performance of the model inference host 504, the model training host 502 may be deployed at a model server as further described herein. Further, in some cases, training and/or inference may be distributed amongst devices in a decentralized or federated fashion.

In some aspects, an ML model is deployed at or on a network entity for UE mobility prediction. More specifically, a model inference host, such as model inference host 504 in FIG. 5, may be deployed at or on the network entity for UE mobility predictions including candidate communication link(s) (e.g., candidate cells and/or beams), communication failure event prediction, measurement event prediction, etc.

In some aspects, an ML model is deployed at or on a UE for UE mobility prediction. More specifically, a model inference host, such as model inference host 504 in FIG. 5, may be deployed at or on the UE for candidate communication link(s) (e.g., candidate cells and/or beams), communication failure event prediction, measurement event prediction, etc.

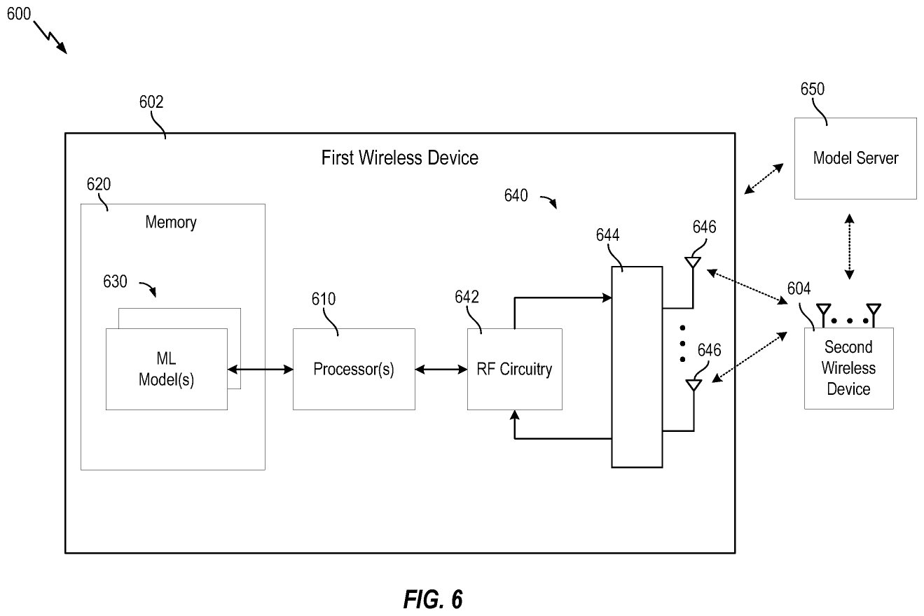

FIG. 6 illustrates an example AI architecture 600 of a first wireless device 602 that is in communication with a second wireless device 604. The first wireless device 602 may be the UE 104 as described herein with respect to FIGS. 1 and 3. Similarly, the second wireless device 604 may be a network entity (or disaggregated entity thereof) as described herein with respect to FIGS. 1 and 2. Note that the AI architecture of the first wireless device 602 may be applied to the second wireless device 604.

The first wireless device 602 may be, or may include, a chip, system on chip (SoC), a system in package (SiP), chipset, package or device that includes one or more processors, processing blocks or processing elements (collectively “the processor 610”) and one or more memory blocks or elements (collectively “the memory 620”).

As an example, in a transmit mode, the processor 610 may transform information (e.g., packets or data blocks) into modulated symbols. As digital baseband signals (e.g., digital in-phase (I) and/or quadrature (Q) baseband signals representative of the respective symbols), the processor 610 may output the modulated symbols to a transceiver 640. The processor 610 may be coupled to the transceiver 640 for transmitting and/or receiving signals via one or more antennas 646. In this example, the transceiver 640 includes radio frequency (RF) circuitry 642, which may be coupled to the antennas 646 via an interface 644. As an example, the interface 644 may include a switch, a duplexer, a diplexer, a multiplexer, and/or the like. The RF circuitry 642 may convert the digital signals to analog baseband signals, for example, using a digital-to-analog converter. The RF circuitry 642 may include any of various circuitry, including, for example, baseband filter(s), mixer(s), frequency synthesizer(s), power amplifier(s), and/or low noise amplifier(s). In some cases, the RF circuitry 642 may upconvert the baseband signals to one or more carrier frequencies for transmission. The antennas 646 may emit RF signals, which may be received at the second wireless device 604.

In receive mode, RF signals received via the antenna 646 (e.g., from the second wireless device 604) may be amplified and converted to a baseband frequency (e.g., downconverted). The received baseband signals may be filtered and converted to digital I or Q signals for digital signal processing. The processor 610 may receive the digital I or Q signals and further process the digital signals, for example, demodulating the digital signals.

One or more ML models 630 may be stored in the memory 620 and accessible to the processor(s) 610. In certain cases, different ML models 630 with different characteristics may be stored in the memory 620, and a particular ML model 630 may be selected based on its characteristics and/or application as well as characteristics and/or conditions of first wireless device 602 (e.g., a power state, a mobility state, a battery reserve, a temperature, etc.). For example, the ML models 630 may have different inference data and output pairings (e.g., different types of inference data produce different types of output), different levels of accuracies (e.g., 80%, 90%, or 95% accurate) associated with the predictions (e.g., the output 514 of FIG. 5), different latencies (e.g., processing times of less than 10 ms, 100 ms, or 1 second) associated with producing the predictions, different ML model sizes (e.g., file sizes), different coefficients or weights, etc.

The processor 610 may use the ML model 630 to produce output data (e.g., the output 514 of FIG. 5) based on input data (e.g., the inference data 512 of FIG. 5), for example, as described herein with respect to the inference host 504 of FIG. 5. The ML model 630 may be used to perform any of various AI-enhanced tasks, such as those listed above.

As an example, the ML model 630 may take UE location information (e.g., positioning coordinates over past period of time) as input to predict a trajectory of the UE and handover targets across the trajectory. The input data may include, for example, UE positions over time and serving cell(s) observed at each of the UE positions. The output data may include, for example, a UE trajectory prediction (e.g., latitude, longitude, altitude, over a future period of time). For example, the UE trajectory prediction may correspond to a morning and/or afternoon commute from home to work, or vice versa. Note that other input data and/or output data may be used in addition to or instead of the examples described herein.

In certain aspects, a model server 650 may perform any of various ML model lifecycle management (LCM) tasks for the first wireless device 602 and/or the second wireless device 604. The model server 650 may operate as the model training host 502 and update the ML model 630 using training data. In some cases, the model server 650 may operate as the data source 506 to collect and host training data, inference data, and/or performance feedback associated with an ML model 630. In certain aspects, the model server 650 may host various types and/or versions of the ML models 630 for the first wireless device 602 and/or the second wireless device 604 to download.

In some cases, the model server 650 may monitor and evaluate the performance of the ML model 630 to trigger one or more LCM tasks. For example, the model server 650 may determine whether to activate or deactivate the use of a particular ML model at the first wireless device 602 and/or the second wireless device 604, and the model server 650 may provide such an instruction to the respective first wireless device 602 and/or the second wireless device 604. In some cases, the model server 650 may determine whether to switch to a different ML model 630 being used at the first wireless device 602 and/or the second wireless device 604, and the model server 650 may provide such an instruction to the respective first wireless device 602 and/or the second wireless device 604. In yet further examples, the model server 650 may also act as a central server for decentralized machine learning tasks, such as federated learning.

### Example Artificial Intelligence Model

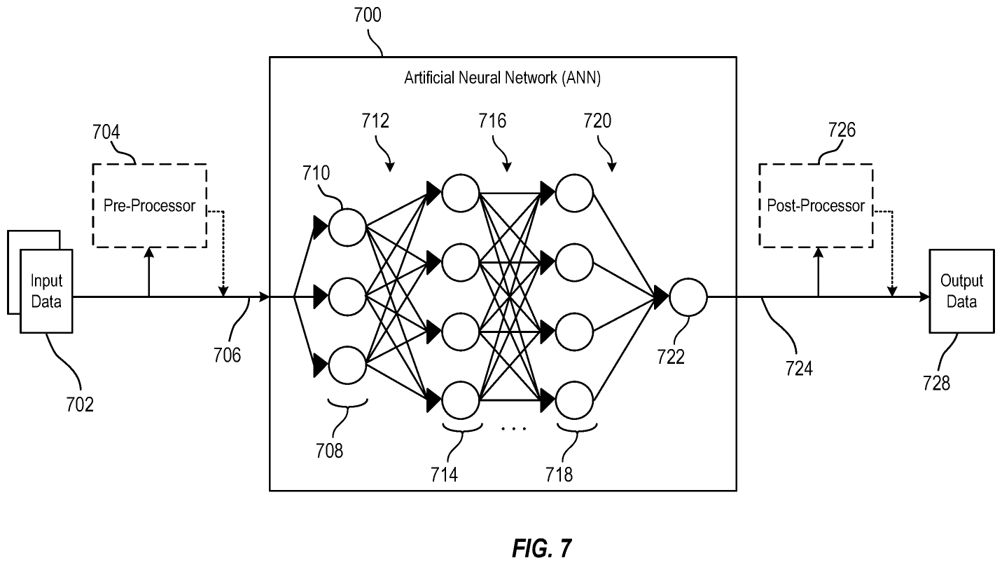

FIG. 7 is an illustrative block diagram of an example artificial neural network (ANN) 700.

ANN 700 may receive input data 706 which may include one or more bits of data 702, pre-processed data output from pre-processor 704 (optional), or some combination thereof. Here, data 702 may include training data, verification data, application-related data, or the like, e.g., depending on the stage of development and/or deployment of ANN 700. Pre-processor 704 may be included within ANN 700 in some other implementations. Pre-processor 704 may, for example, process all or a portion of data 702 which may result in some of data 702 being changed, replaced, deleted, etc. In some implementations, pre-processor 704 may add additional data to data 702.

ANN 700 includes at least one first layer 708 of artificial neurons 710 (e.g., perceptrons) to process input data 706 and provide resulting first layer output data via edges 712 to at least a portion of at least one second layer 714. Second layer 714 processes data received via edges 712 and provides second layer output data via edges 716 to at least a portion of at least one third layer 718. Third layer 718 processes data received via edges 716 and provides third layer output data via edges 720 to at least a portion of a final layer 722 including one or more neurons to provide output data 724. All or part of output data 724 may be further processed in some manner by (optional) post-processor 726. Thus, in certain examples, ANN 700 may provide output data 728 that is based on output data 724, post-processed data output from post-processor 726, or some combination thereof. Post-processor 726 may be included within ANN 700 in some other implementations. Post-processor 726 may, for example, process all or a portion of output data 724 which may result in output data 728 being different, at least in part, to output data 724, e.g., as result of data being changed, replaced, deleted, etc. In some implementations, post-processor 726 may be configured to add additional data to output data 724. In this example, second layer 714 and third layer 718 represent intermediate or hidden layers that may be arranged in a hierarchical or other like structure. Although not explicitly shown, there may be one or more further intermediate layers between the second layer 714 and the third layer 718.

The structure and training of artificial neurons 710 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 506 in FIG. 5). Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 700 and a number of layers and a number of artificial neurons in each layer, as well as selecting activation functions, a loss function, training processes, etc. Once an initial model has been designed, training of the model may be conducted using training data. Training data may include one or more datasets within which ANN 700 may detect, determine, identify or ascertain patterns. Training data may represent various types of information, including written, visual, audio, environmental context, operational properties, etc. During training, parameters of artificial neurons 710 may be changed, such as to minimize or otherwise reduce a loss function or a cost function. A training process may be repeated multiple times to fine-tune ANN 700 with each iteration.

Various ANN model structures are available for consideration. For example, in a feedforward ANN structure each artificial neuron 710 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, or other like processing.

Another example type of ANN structure, is a model with one or more invertible layers. Models of this type may be inverted or “unwrapped” to reveal the input data that was used to generate the output of a layer.

Other example types of ANN model structures include fully connected neural networks (FCNNs) and long short-term memory (LSTM) networks.

ANN 700 or other ML models may be implemented in various types of processing circuits along with memory and applicable instructions therein, for example, as described herein with respect to FIGS. 5 and 6. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

### Aspects of Artificial Intelligence Model Training

There are a variety of model training techniques and processes that may be used prior to, or at some point following, deployment of an ML model, such as ANN 700 of FIG. 7.

As part of a model development process, information in the form of applicable training data may be gathered or otherwise created for use in training an ML model accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in one or more user equipments (UEs), one or more network entities, or one or more other devices in a wireless communication system. In some cases, all or part of the training data may be aggregated from multiple sources (e.g., one or more UEs, one or more network entities, the Internet, etc.). For example, wireless network architectures, such as self-organizing networks (SONs) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like. Offline training may refer to creating and using a static training dataset, e.g., in a batched manner, whereas online training may refer to a real-time or near-real-time collection and use of training data. For example, an ML model at a network device (e.g., a UE) may be trained and/or fine-tuned using online or offline training. For offline training, data collection and training can occur in an offline manner at the network side (e.g., at a base station or other network entity) or at the UE side. For online training, the training of a UE-side ML model may be performed locally at the UE or by a server device (e.g., a server hosted by a UE vendor) in a real-time or near-real-time manner based on data provided to the server device from the UE.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 700 of FIG. 7, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training on data distributed across multiple devices or organizations, without the need to centralize data or the training. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ML model to be trained on data collected from a wide range of devices and environments. For example, an ML model may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a model and perform local training on such copy of all or part of the model using locally available training data. Such a device may provide update information (e.g., trainable parameter gradients) regarding the locally trained model to one or more other devices (such as a network entity or a server) where the updates from other-like devices (such as other UEs) may be aggregated and used to provide an update to a shared model or the like. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, e.g., to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a central unit (CU), a distributed unit (DU), a radio unit (RU), or the like.

### Aspects Related to Prediction-Based Mobility Management

Aspects described herein provide various schemes for configuring a UE based on a UE mobility prediction to enhance the mobility performance. The techniques for mobility management described herein may enable improved wireless communication performance, such as reduced latencies, packet losses, handover failures, premature handovers, and/or ping-ponging between network entities.

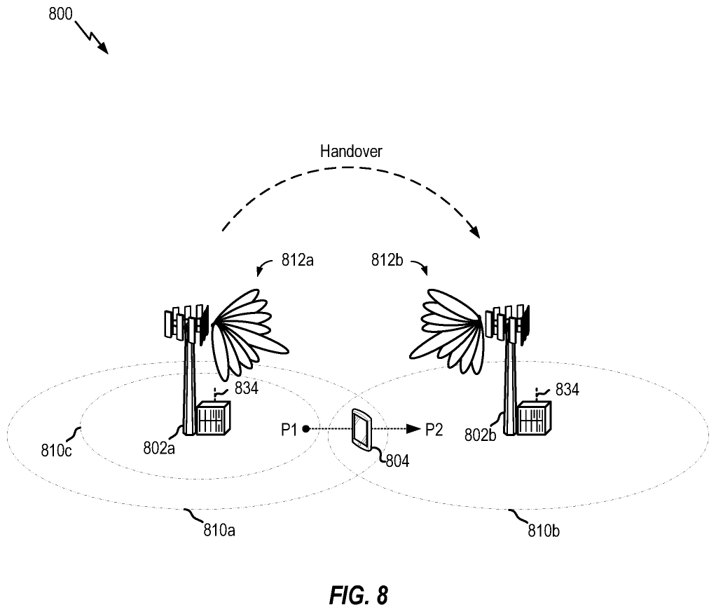

FIG. 8 depicts an example of UE mobility in a wireless communications network 800. In this example, the wireless communication network 800 may include a first network entity 802a having a first coverage area 810a and a second network entity 802b having a second coverage area 810b, which may overlap with the first coverage area 810a. The first network entity 802a may also have a third coverage area 810c. In certain aspects, the first coverage area 810a may form a first cell, the second coverage area 810b may form a second cell, and the third coverage area 810c may form a third cell. The first cell and third cell may form a first cell group, and the second cell may form a second cell group. The first network entity 802a may communicate via a first set of beams 812a, and the second network entity 802b may communicate via a second set of beams 812b.

Due to mobility (e.g., a UE 804 moving from the first coverage area 810a to the second coverage area 810b), the UE 804 may transition from communicating with the first network entity 802a via the first set of beams 812a to communicating with the second network entity 802b via the second set of beams 812b. As an example, the UE 804 may be located at a first position P1 in the first coverage area 810a and/or the third coverage area 810c at a first occasion, and then the UE 804 may move to a second position P2 in the second coverage area 810b at a second, later occasion.

In some cases, the UE 804 may send a measurement report to the first network entity 802a. The measurement report may indicate radio measurements (e.g., signal strengths) associated with the serving cell of the first network entity 802a and neighboring cell(s) of the second network entity 802b. In certain cases, the measurement report may indicate the signal strengths associated certain beam(s) of the serving cell and the neighboring cell(s), such as the first set of beams 812a and/or the second set of beams 812b. Based on the measurement report (e.g., indicating a stronger signal strength associated with radio measurements for the second network entity 802b relative to the first network entity 802a), the first network entity 802a may determine to handover (HO) communications with the UE 804 to the second network entity 802b. The first network entity 802a may be in communication with the second network entity 802b via a backhaul link 834 (e.g., an F1, Xn, and/or NG interface) in order to exchange information for the handover. In the context of a handover, the first network entity 802a may be referred to as a source network entity, which may represent a point of origin for the HO; and the second network entity 802b may be referred to as a target or candidate network entity, which may represent the destination or a candidate destination for the handover.

In some cases, the handover may involve a CU/DU handover, such as inter-DU-intra-CU handover and/or inter-CU handover. For example, the handover may involve a handover from a source DU to a target or candidate DU in communication with a common CU. The handover may involve a handover from a source CU to a target or candidate CU. Accordingly, the first network entity 802a and/or the second network entity 802b may be an example of an RU, DU, and/or CU.

With respect to an ML-based UE mobility prediction, an ML model (e.g., the ANN 700 and/or the ML model 630) may be fed input data to predict a UE trajectory (e.g., a prediction of UE positions over time), which may be used to determine candidates for handover target(s) (e.g., beam(s), cell(s), and/or cell group(s)) along the trajectory. For example, the ML model may predict the trajectory of UE 804 to move from P1 to P2, and thus, the trajectory may indicate that the second network entity 802b is available as a handover target when the UE 804 moves within the second coverage area 810b. In some cases, the ML model may generate a prediction of handover target(s) (e.g., beam(s), cell(s), and/or cell group(s)). For example, the ML model may predict that the second network entity 802b is a handover target when the UE 804 moves within the second coverage area 810b.

The input data for ML-based UE mobility prediction may include UE location information (e.g., UE positions over time), radio measurements (e.g., a reference signal received power (RSRP), a reference signal received quality (RSRQ), and/or a signal-to-interference plus noise ratio (SINR)) for serving cell and/or neighboring cell(s), such as associated with UE location information, UE mobility history information, etc. The output data for ML-based UE mobility prediction may include a UE trajectory prediction, a predicted handover target (e.g., beam(s), cell(s), and/or cell group(s)), an estimated arrival time and time interval for a UE to encounter a handover target (e.g., a time period during which the UE is expected to arrive within a suitable transmission range of a handover target), UE traffic prediction, etc.

Note that the handover illustrated in FIG. 8 is an example of a mobility operation. Aspects of the present disclosure described herein with respect to prediction-based mobility management may be applied to various types of UE mobility operations including, for example, an Xn based handover, an N2 based handover, lower-layered triggered mobility (LTM), conditional handover, beam selection, beam switch, serving cell modification, serving cell addition, serving cell release, cell group modification, cell group addition, cell group release, etc. A handover may be triggered, for example, due to radio conditions (e.g., in response to a measurement report), load balancing at a network entity, and/or a specific service (e.g., to ensure wireless communications performance that satisfies a QoS specification).

An LTM may refer to a specific type of handover scheme that enables a serving cell change via Layer-1 (e.g., DCI) and/or Layer-2 signaling (e.g., medium access control signaling), while keeping configuration of the upper layers (e.g., RRC configuration(s)) and/or reducing changes of configuration of the lower layers. An LTM-based handover helps reduce the latency, overhead and interruption time during handover. LTM may be performed for intra-DU and/or intra-CU-inter-DU mobility. During LTM, a user plane session may be maintained with the target or candidate cell for intra-DU mobility, without reset, to avoid or minimize packet losses and/or additional latencies.

### Aspects Related to Validity of Mobility Prediction and Configuration

In certain aspects, a UE may be configured (e.g., via a pre-configuration and/or signaling) with a validity time associated with a mobility configuration and/or a mobility prediction. The validity time may define a time period during which the mobility configuration and/or mobility prediction can be used at a UE for mobility operation(s), such as any of various types of mobility operations described above. The validity time may apply to mobility prediction(s) generated by a UE and/or a network entity (or model server). In certain cases, a mobility operation may be or include a communication link modification, such as a conditional handover (including a conditional handover with multiple SCGs), LTM, conditional LTM, conditional serving cell addition, conditional serving cell change, etc. In certain aspects, the mobility configuration and/or mobility prediction may be communicated via radio resource control (RRC) signaling, medium access control (MAC) signaling, downlink control information (DCI), and/or system information. In some cases, the UE may obtain the mobility prediction via separate signaling from the mobility configuration. For example, the UE may obtain a condition mobility configuration via RRC signaling, and the UE may obtain a mobility prediction via DCI and/or MAC signaling. For example, the UE may obtain an indication that the mobility prediction is associated with (e.g., applicable to) a particular mobility configuration.

In certain aspects, the mobility configuration may indicate the mobility prediction for a communication link modification (e.g., a mobility operation). The mobility prediction may be or include a prediction of one or more candidate communication links. A communication link may include a beam, a cell, and/or a cell group for wireless communications between a UE and a network entity. The mobility configuration may indicate the candidate communication link(s) available for a UE to switch from a source communication link to a target communication link of the candidate communication link(s) based on one or more criteria that trigger the communication link modification.

In certain aspects, the mobility prediction may include a UE trajectory prediction (which may indicate candidate communication link(s)), a predicted handover target (e.g., beam(s), cell(s), and/or cell group(s)), an estimated arrival time and time interval for a UE to encounter candidate communication link(s) (e.g., handover or beam switch target(s)), UE traffic prediction, or the like. The estimated arrival time and time interval may indicate a time period during which the UE is expected to encounter a candidate communication link (e.g., when the UE is expected to arrive within a suitable transmission range of a network entity via a candidate communication link). For example, as the UE 804 moves from P1 to P2, the estimated arrival time for the UE 804 to encounter the second coverage area 810b may be expected to occur a particular time (e.g., the arrival time) within a certain time interval (e.g., within a margin of error or other buffer for the prediction). In some cases, the mobility prediction may include a prediction of communication failure event(s) for candidate communication link(s) and/or a prediction of measurement event(s) that trigger radio measurements, which may be used to determine handover or beam switch target(s).

In certain aspects, the validity time may be implemented via a validity timer that starts running when the mobility configuration and/or mobility prediction is communicated. For example, when the UE obtains the mobility configuration and/or a mobility prediction, the UE may start the validity timer. Upon expiration of the validity timer, the UE may refrain from using the mobility configuration and/or mobility prediction for mobility operation(s). For example, the UE may release or discard the mobility configuration and/or mobility prediction.

The UE may start or reset the validity timer in response to various events. As an example, the UE may obtain an indication to start or reset the validity timer from a network entity. In certain aspects, the indication to start or reset the validity timer may be implicit. For example, the UE may obtain an updated mobility prediction (including a set candidate communication links) and/or an updated mobility configuration, which may trigger the UE to start or reset the validity timer. In certain aspects, the UE may start or reset the validity timer for a mobility prediction when the UE generates the mobility prediction. In certain aspects, the network entity may start or reset the validity timer for the mobility prediction when the network entity generates the mobility prediction, and the network entity may indicate to the UE the remaining time left for the validity timer when the network entity sends the mobility prediction to the UE.

In certain aspects, the UE may obtain an indication for the duration for the validity time. As an example, the duration for the validity time may be communicated with the mobility configuration and/or mobility prediction. In certain cases, the duration for the validity time may be determined based on the mobility configuration and/or mobility prediction. For example, the validity time may be determined based on an estimated arrival time and time interval for a UE to encounter candidate communication link(s). In some cases, the UE may be preconfigured with a duration for the validity time.

In certain aspects, the UE may obtain an indication that the mobility configuration and/or the mobility prediction is deactivated. For example, the UE may obtain, from a network entity, an indication to refrain from using a particular mobility configuration and/or mobility prediction.

### Aspects Related to Prediction-Based Criteria for Mobility Configuration

In certain aspects, a UE may be configured (e.g., via a pre-configuration and/or signaling) with certain event(s) and/or criteria that trigger a mobility operation (e.g., a communication link modification). For example, the mobility configuration discussed above may indicate or include one or more criteria that trigger a communication link modification based on a mobility prediction generated at a UE.

When the UE-generated mobility prediction includes candidate communication link(s) (e.g., a handover or beam switch target or candidate), the mobility prediction may further include a probability of the UE encountering a candidate communication link, an expected arrival time and/or time interval for encountering the candidate communication link, and/or a duration of suitability for the candidate communication link. The arrival time and/or time interval for encountering the candidate communication link may indicate a particular time when the candidate communication link is available to perform the communication link modification. The duration of suitability may define a time period during which the candidate communication link is expected to be available for communications.

In certain aspects, the criteria that trigger(s) the communication link modification may depend on the mobility prediction generated at the UE. In some cases, the criteria may include a first criteria that the probability of encountering a candidate communication link of the UE-generated mobility prediction satisfies a first threshold. For example, when the probability exceeds a threshold, the UE may perform the communication link modification. The criteria may include a second criteria that a difference between a current time and an expected arrival time for the candidate communication link satisfies a second threshold. For example, when the current time is within a time interval of the expected arrival time, the UE may perform the communication link modification. The criteria may include a third criteria that a duration of suitability for the candidate communication link satisfies a third threshold. For example, when the duration of suitability exceeds a threshold, the UE may perform the communication link modification. In certain aspects, the criteria may include any combination of the first criteria, second criteria, and/or third criteria discussed above. The criteria that trigger(s) the communication link modification may also depend on radio measurements for the candidate communication link.

The criteria that trigger(s) the communication link modification may be communicated via RRC signaling, MAC signaling, DCI, and/or system information. In some cases, the criteria that trigger(s) the communication link modification may be preconfigured.

### Aspects Related to Feedback for Mobility Prediction

In certain aspects, a UE may send, to a network entity, feedback associated with a mobility prediction. The feedback may enable the network entity to adjust certain parameter(s) of a mobility configuration and/or evaluate the performance of an ML model used to generate the mobility prediction. For example, a network entity may adjust the criteria that trigger(s) a communication link modification based on the feedback. In some cases, the feedback may trigger the network entity to retrain the ML model used to generate the mobility prediction. The feedback may be implicit or explicit.

In certain aspects, the UE may obtain, from a network entity, an indication for the UE to provide feedback associated with a mobility prediction. For example, the UE may obtain a list of candidate communication links along with an indication the list was determined based on an ML prediction. The UE may obtain a handover command that indicates the handover target was determined based on an ML prediction. Such indications that the candidate(s) and/or target(s) are determined based on an ML prediction may indicate to the UE to provide feedback to the network entity.

The feedback may include a feedback report, such as a radio link failure report, a cell group failure information (including SCG failure information), a successful handover report (SHR), and/or a successful primary serving cell change report (SPR). In certain aspects, a primary serving cell may be or include a primary serving cell (PCell) for a master cell group (MCG) and/or a primary cell for a secondary cell group (e.g., a primary secondary cell group (SCG) cell (PSCell)). The feedback may include an indication of whether target cell(s) or beam(s) were determined based on ML prediction. When the UE generates a mobility prediction, the feedback may include the UE-generated mobility prediction, such as handover or beam switch targets predicted by the UE. The UE-generated prediction may allow the network entity to evaluate the performance of the ML model deployed at or on the UE and/or another ML model deployed at or on the network entity.

In certain aspects, the UE may send, to the network entity, the UE-generated mobility prediction before obtaining an indication to perform a communication link modification, such as a handover command, LTM command, a primary serving cell change command, and/or a primary serving cell addition command.

### Aspects Related to Conditional Configuration Based on Mobility Prediction

In certain aspects, a UE may be configured with conditional configuration(s) (e.g., separate from a mobility configuration) based on a mobility prediction. For example, a network entity may determine conditional configuration(s) for communications between the UE and the network entity based on a mobility prediction, and the UE may obtain, from the network entity, the conditional configuration(s). The mobility prediction may enable the network entity to determine criteria for triggering the application of the configuration and/or criteria for selection of parameters for the configuration. As an example, a network entity (e.g., a source CU) may determine an LTM configuration based on a mobility prediction (e.g., a UE trajectory). As the UE trajectory may indicate which beams the UE is expected to encounter along the trajectory, the LTM configuration may indicate a list of reference signals (e.g., SSB(s)/CSI-RS(s) or identifiers thereof) of the serving and/or candidate cells for Layer-1 measurement and/or reporting.

The conditional configuration(s) may be or include a radio link monitoring (RLM) configuration, a beam failure detection (BFD) configuration, a configuration for random access communications (e.g., preamble sequence, contention-free resources, etc.), a configuration for performing and/or reporting Layer-1 and/or Layer-3 radio measurements, or the like. The configuration(s) may apply to a source cell, candidate cell, and/or a target cell. The configuration(s) may apply to multi-connectivity scenarios, such as a secondary node and/or SCG. For example, the configuration(s) may include RLM and BFD configurations for a serving SN (e.g., a source SCG) or target/candidate SN (e.g., a target or candidate SCG).

A conditional configuration may have a first set of criteria that trigger the application of the configuration and/or a second set of criteria used to select certain parameter(s) for the configuration. The first set of criteria may define scenarios or conditions (e.g., a time, time interval, position, and/or area) for where and/or when the configuration can be used by a UE. The first set of criteria may include a first criteria that a current time satisfies a threshold, a second criteria that a trajectory of a UE matches (or is within) an expected trajectory, and/or a third criteria that a position (e.g., longitude, latitude, and/or elevation) of the UE matches an expected position.

The second set of criteria may define scenarios or conditions for selection of certain parameter(s) for the configuration. In some cases, the second set of criteria may include a set of UE velocity thresholds (e.g., 0<thresh_1<=thresh_2<= . . . <=thresh_N), and the periodicity for when to perform radio measurements of reference signal(s) at a UE may be determined based on the thresholds. The measurement periodicity may be a function of threshold interval (e.g., the interval of (thresh_i, thresh_i+1]) in which the UE velocity resides. For example, when the UE is moving at a low velocity, the set of beams providing coverage to the UE may effectively be static, and the periodicity of radio measurements performed at the UE may be set quite large (e.g., the UE measures less frequently). When the UE is moving at a high velocity, the set of beams providing coverage to the UE may change frequently, and the periodicity of radio measurements performed at the UE may be set to a smaller interval (e.g., the UE measures more frequently). In some cases, the second set of criteria may include a set of time interval thresholds (e.g., 0<time_1<=time_2<= . . . <=time N), and for each time interval (e.g., the interval of (time_i, time_i+1]), the UE may be configured with a set of beams to measure, for example, for RLM and/or BFD.

In certain aspects, a first network entity may send any of the conditional configurations to a second network entity, for example, via a backhaul link (e.g., the backhaul link 834). The transfer of the conditional configurations to a candidate or target network entity may allow such network entity to prepare for communications with a UE based on the conditional configurations. As an example, a source network entity may send the conditional configurations to a target network entity for handover preparation. For LTM preparation, a CU may send the conditional configurations to a source DU and/or a target or neighbor DU. A master node of a MCG may send the conditional configurations to a secondary node of a SCG during LTM preparation.

In certain aspects, a target and/or candidate network entity may send, to a source network entity, a request for modifications to the conditional configuration proposed by the source network entity (or vice versa). For example, the target and/or candidate network entity may request that a UE be configured with additional or alternative measurement objects (e.g., SSBs or CSI-RSs) for radio measurements. The target network entity may determine the modification based on any UE mobility information provided to the target network entity during preparation for the handover (for example, from the source network entity). The target network entity may determine the modification based on mobility information that the target network entity has generated, such as a prediction of cell load and/or beam load.

### Example Signaling for Prediction-Based Mobility Management

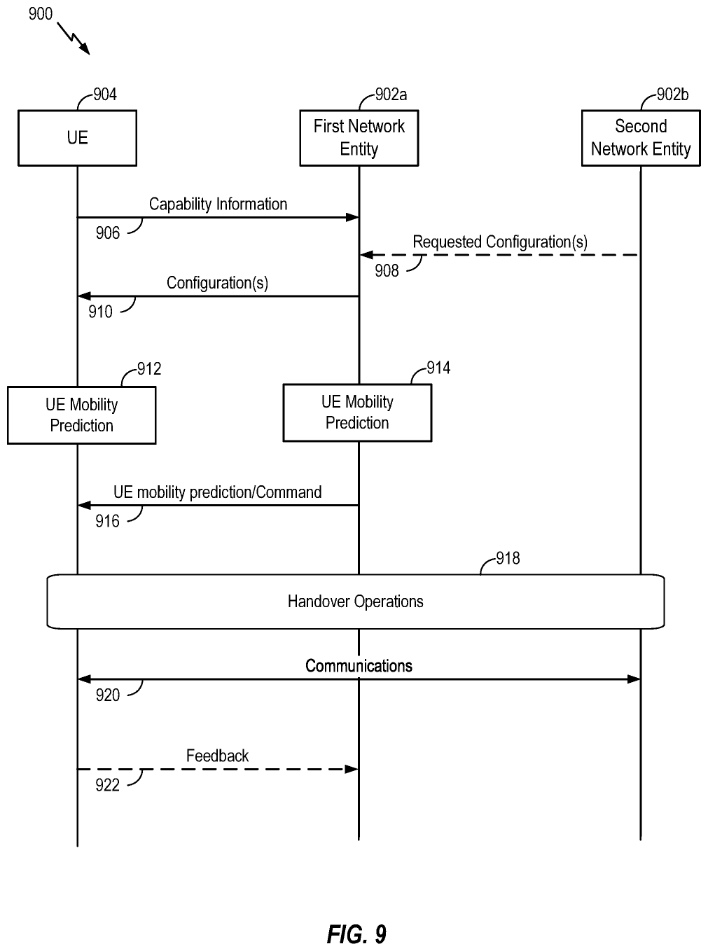

FIG. 9 depicts a process flow 900 for prediction-based mobility management in a system between a first network entity 902a, a second network entity 902b, and a user equipment (UE) 904. In some aspects, the first network entity 902a and/or the second network entity 902b may be an example of the BS 102 depicted and described with respect to FIGS. 1 and 3 or a disaggregated base station depicted and described with respect to FIG. 2. Similarly, the UE 904 may be an example of UE 104 depicted and described with respect to FIGS. 1 and 3. However, in other aspects, UE 904 may be another type of wireless communications device. The first network entity 902a and/or the second network entity 902b may be another type of network entity or network node, such as those described herein. Note that any operations or signaling illustrated with dashed lines may indicate that that operation or signaling may be an optional or alternative example.

At 906, the UE 904 sends, to the first network entity 902a, capability information associated with ML-based UE mobility prediction. The capability information may indicate that the UE 904 is capable of generating a ML-based UE mobility prediction, such as a UE trajectory prediction, a handover target prediction, a candidate communication link prediction, a communication failure event prediction, and/or a measurement event prediction.

At 908, the first network entity 902a obtains, from the second network entity 902b, a request for certain configuration(s), such as a modification to a conditional configuration as discussed above.

At 910, the UE 904 obtains, from the first network entity 902a, one or more mobility configurations and/or one or more conditional configurations, for example, as discussed above. The configuration(s) may indicate one or more parameters for ML-based UE mobility prediction, such as probability, confidence, validity, time of encountering, duration of suitability, etc. The mobility configuration(s) may have a validity time during which the UE 904 is allowed to use the respective mobility configuration(s). The validity time may be indicated with the configuration(s) and/or pre-configured at the UE 904. The mobility configuration(s) may have certain prediction-based criteria (e.g., probability, arrival time (or interval), and/or a suitability duration) that trigger a mobility operation. The conditional configuration(s) may be configured based on a mobility prediction as discussed above. In certain aspects, the conditional configuration(s) may be specified for communications with the first network entity 902a and/or the second network entity 902b. For example, based on a mobility prediction that indicates the UE 904 is expected to encounter a coverage area of the second network entity 902b, the conditional configuration(s) may prepare the UE 904 for communications with the second network entity 902b as further described below. The conditional configuration(s) may be or include a RLM configuration, a BFD configuration, a configuration for random access communications, a configuration for performing and/or reporting Layer-1 and/or Layer-3 radio measurements associated with source, candidate, neighbor, and/or target communication link(s) including communication link(s) for the first network entity 902a and/or the second network entity 902b. Any of the configuration(s) may be communicated via RRC signaling, MAC signaling, DCI, and/or system information.

At 912, the UE 904 generates a UE mobility prediction, for example, as discussed above. The UE mobility prediction may be or include a UE trajectory prediction, a handover target prediction, a prediction of candidate communication link(s), a prediction of communication failure event(s), and/or a prediction of measurement event(s). As an example, the UE 904 may provide an ML model input data, which may be or include any of the information discussed above. For example, the input data may be or include UE location information (e.g., UE positions over time), radio measurements for serving cell and neighboring cells associated with UE location information, UE mobility history information, etc. The UE mobility history information may include a list of recently visited primary cells and/or time spent in any cell selection state and/or camped on any cell state. The UE 904 may obtain, from the ML model, output data that comprises an indication of a UE mobility prediction, such as a UE trajectory prediction, a handover target prediction, a prediction of candidate communication link(s), a prediction of communication failure event(s), and/or a prediction of measurement event(s).

At 914, the first network entity 902a generates a UE mobility prediction. The UE mobility prediction may be or include a UE trajectory prediction, a handover target prediction, a prediction of candidate communication link(s), a prediction of communication failure event(s), and/or a prediction of measurement event(s). The first network entity 902a may provide an ML model input data, which may be or include any of the information discussed above. The first network entity 902a may obtain, from the ML model, output data that comprises an indication of a UE mobility prediction. Note that, in some cases, the second network entity 902b may generate a UE mobility prediction.

At 916, the UE 904 obtains, from the first network entity 902a, an indication of a UE mobility prediction, such as a UE trajectory prediction, a handover target prediction, a prediction of candidate communication link(s), a prediction of communication failure event(s), and/or a prediction of measurement event(s). In some cases, the UE mobility prediction may be implicitly conveyed via a list of candidates for handover or beam switch and/or a handover or beam switch command. The UE mobility prediction may have a validity time during which the UE is allowed to use the UE mobility prediction. The validity time may be indicated with the UE mobility prediction and/or preconfigured at the UE 904.

At 918, the UE 904 performs a handover, for example, based on the UE mobility prediction determined at 912 and/or 914 and/or indicated at 916. The UE 904 may perform the handover before expiration of a validity timer associated with a mobility configuration and/or the UE mobility prediction. The UE 904 may perform the handover based on certain prediction-based criteria, such as probability of the UE encountering a candidate communication link, an expected arrival time and/or time interval for encountering the candidate communication link, and/or a duration of suitability for the candidate communication link. As an example, the UE 904 and/or the first network entity 902a may determine a handover target based on the UE mobility prediction. In some cases, the UE mobility prediction may indicate a UE trajectory and/or the handover target. The UE mobility prediction may indicate that the UE is expected to encounter communication failure event(s) for other handover candidate(s). The UE mobility prediction may indicate a measurement event associated with triggering a handover to the handover target. Accordingly, the handover may be performed with reduced latency and/or packet losses due to the validity timer and/or the prediction-based criteria ensuring the accuracy and/or reliability of the UE mobility prediction. In certain cases, a handover failure and/or ping-ponging may be avoided due to the validity timer and/or the prediction-based criteria ensuring the accuracy and/or reliability of the UE mobility prediction.

At 920, the UE 904 communicates with the second network entity 902b. For example, the handover operations may enable the UE 904 to maintain service continuity via a cell or beam of the second network entity 902b. In certain aspects, the UE 904 may communicate with the second network entity 902b according to certain conditional configurations obtained at 910, for example, as discussed above. The conditional configurations may ensure reliable communications between the UE 904 and the second network entity 902b in accordance with the mobility prediction. As an example, the conditional configuration may provide contention free resources for random access communications to ensure reliable and low latency access to the second network entity 902b when the UE 904 encounters the coverage area of the second network entity 902b.

At 922, the UE 904 sends, to the first network entity 902a, feedback associated with the UE mobility prediction obtained at 916. The feedback may include UE-generated mobility prediction, such as handover or beam switch targets predicted by the UE at 912. The first network entity 902a may evaluate its mobility prediction and/or the UE's mobility prediction based on the feedback. For example, the feedback may indicate that the UE predicted a different handover target than the handover command, and in response to the feedback, the first network entity 902a may retrain the ML model deployed at the UE 904 and/or the other ML model deployed at the first network entity 902a. Accordingly, the feedback may ensure that the ML model(s) deployed at the UE 904 and/or the first network entity 902a are suitable for reliable prediction-based mobility management.

Note that the handover illustrated in FIG. 9 is an example of a mobility operation, and other mobility operations may be performed in accordance with the techniques for prediction-based mobility management described herein.

### Example Operations for Prediction-Based Mobility Management

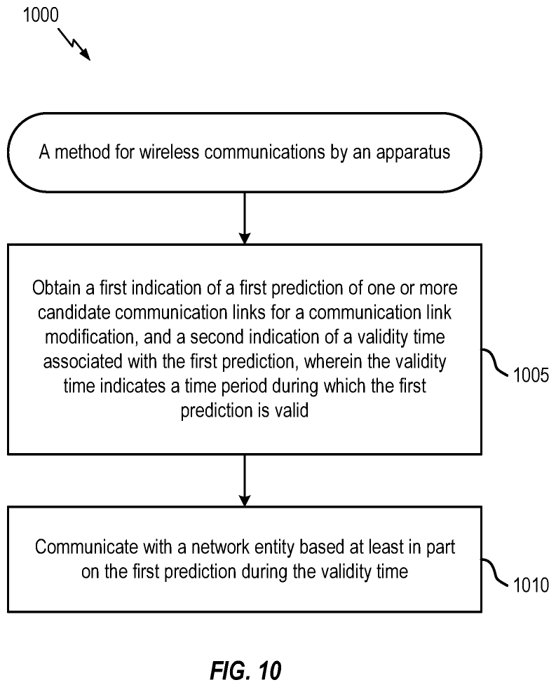

FIG. 10 shows a method 1000 for wireless communications by an apparatus, such as UE 104 of FIGS. 1 and 3.

Method 1000 begins at block 1005 with obtaining a first indication of a first prediction of one or more candidate communication links for a communication link modification, and a second indication of a validity time associated with the first prediction, wherein the validity time indicates a time period during which the first prediction is valid. In certain aspects, the one or more candidate communication links comprises one or more of: one or more cell groups; a first set of candidate cells; or a second set of candidate beams.

Method 1000 then proceeds to block 1010 with communicating with a network entity based at least in part on the first prediction during the validity time. In certain aspects, block 1010 includes switching from communicating via a source communication link to a target communication link, the target communication link selected among the one or more candidate communication links.

In certain aspects, method 1000 further includes obtaining a configuration that indicates one or more criteria that trigger the communication link modification based on the first prediction. In certain aspects, the communication link modification comprises one or more of: a beam switch; a conditional handover; lower-layered triggered mobility; a serving cell change; a serving cell addition; or a serving cell release. In certain aspects, the one or more criteria comprise one or more of: a first criteria that a probability of encountering at least one candidate communication link of the one or more candidate communication links satisfies a first threshold; a second criteria that a difference between a current time and an expected arrival time for the at least one candidate communication link satisfies a second threshold; or a third criteria that a duration of suitability for the at least one candidate communication link satisfies a third threshold. In certain aspects, the configuration is valid during the validity time. In certain aspects, the second indication of the validity time comprises a validity timer that starts running when the first prediction is communicated. In certain aspects, method 1000 further includes releasing the configuration upon expiration of the validity timer.

In certain aspects, method 1000 further includes obtaining a third indication to perform the communication link modification.

In certain aspects, method 1000 further includes performing the communication link modification for a target communication link based on the first prediction.

In certain aspects, method 1000 further includes sending feedback associated with the communication link modification, wherein the feedback indicates the target communication link is based on the first prediction. In certain aspects, the feedback comprises one or more of: an indication of a radio link failure for at least one candidate communication link of the one or more candidate communication links; an indication of a beam failure for the at least one candidate communication link; cell group failure information for the at least one candidate communication link; a handover report for the at least one candidate communication link; or a serving cell report for the at least one candidate communication link.

In certain aspects, method 1000 further includes determining a second prediction of at least one candidate communication link, wherein the feedback comprises the second prediction.

In certain aspects, method 1000 further includes obtaining a configuration for communications via at least one candidate communication link of the one or more candidate communication links, wherein the configuration indicates a first set of criteria that trigger application of the configuration and indicates a second set of criteria for selection of one or more parameters of the configuration. In certain aspects, method 1000 further includes communicating via the at least one candidate communication link based on the configuration. In certain aspects, the first set of criteria comprises one or more of: a first criteria that a current time satisfies a threshold; a second criteria that a trajectory of the apparatus matches an expected trajectory; or a third criteria that a position of the apparatus matches an expected position. In certain aspects, the second set of criteria comprises one or more of: a first criteria that a velocity of the apparatus satisfies a first threshold; or a second criteria that a current time is within a time interval of a set of time intervals. In certain aspects, the configuration comprises one or more of: a first configuration for radio link monitoring; a second configuration for beam failure detection; a third configuration for random access communications; or a fourth configuration for channel measurement. In certain aspects, the one or more parameters comprises a set of reference signals for channel measurement and reporting.

In certain aspects, method 1000 further includes providing input data to a ML model, wherein the input data comprises the first prediction. In certain aspects, method 1000 further includes obtaining, from the ML model, output data comprising a second prediction of the one or more candidate communication links for the communication link modification; and block 1010 includes communicating with the network entity further based at least in part on the second prediction.

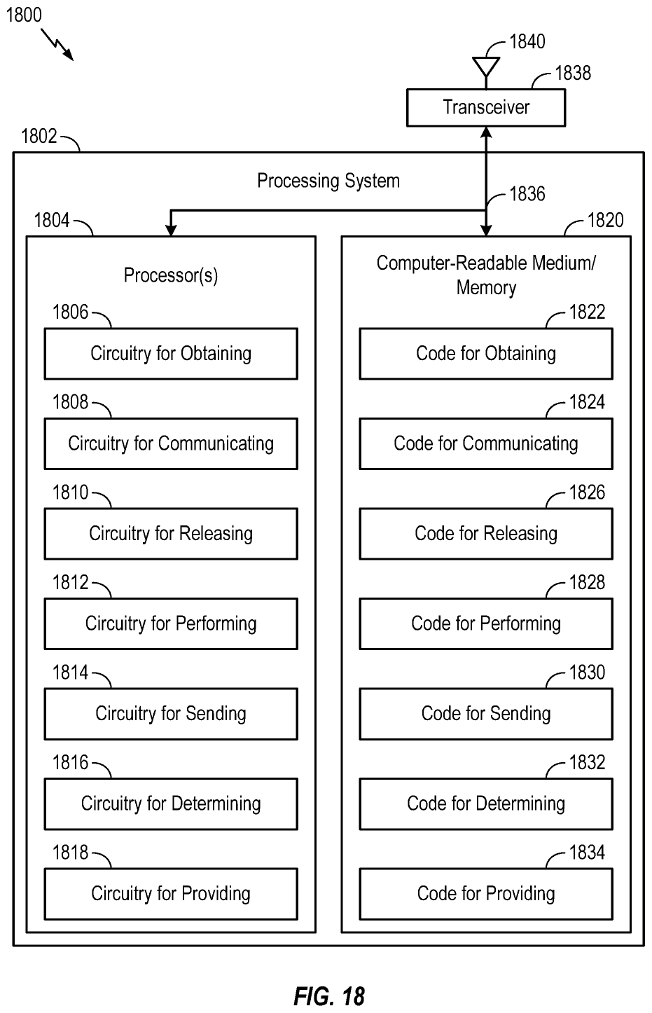

In certain aspects, method 1000, or any aspect related to it, may be performed by an apparatus, such as communications device 1800 of FIG. 18, which includes various components operable, configured, or adapted to perform the method 1000. Communications device 1800 is described below in further detail.

Note that FIG. 10 is just one example of a method, and other methods including fewer, additional, or alternative operations are possible consistent with this disclosure.

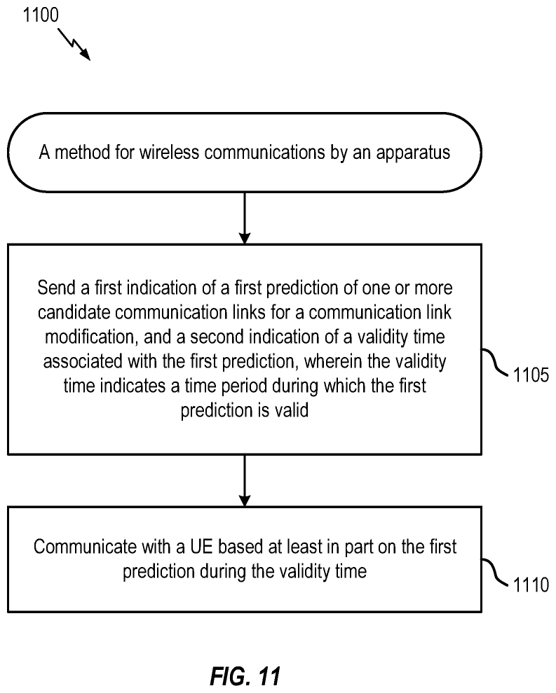

FIG. 11 shows a method 1100 for wireless communications by an apparatus, such as BS 102 of FIGS. 1 and 3, or a disaggregated base station as discussed with respect to FIG. 2.

Method 1100 begins at block 1105 with sending a first indication of a first prediction of one or more candidate communication links for a communication link modification, and a second indication of a validity time associated with the first prediction, wherein the validity time indicates a time period during which the first prediction is valid. In certain aspects, the one or more candidate communication links comprises one or more of: one or more cell groups; a first set of candidate cells; or a second set of candidate beams. In certain aspects, the second indication of the validity time comprises a validity timer that starts running when the first prediction is communicated. In certain aspects, method 1100 further includes releasing the configuration upon expiration of the validity timer.

Method 1100 then proceeds to block 1110 with communicating with a UE based at least in part on the first prediction during the validity time. In certain aspects, block 1110 includes switching from communicating via a source communication link to a target communication link, the target communication link selected among the one or more candidate communication links.

In certain aspects, method 1100 further includes sending a configuration that indicates one or more criteria that trigger the communication link modification based on the first prediction. In certain aspects, the communication link modification comprises one or more of: a beam switch; a conditional handover; lower-layered triggered mobility; a serving cell change; a serving cell addition; or a serving cell release. In certain aspects, the one or more criteria comprise one or more of: a first criteria that a probability of encountering at least one candidate communication link of the one or more candidate communication links satisfies a first threshold; a second criteria that a difference between a current time and an expected arrival time for the at least one candidate communication link satisfies a second threshold; or a third criteria that a duration of suitability for the at least one candidate communication link satisfies a third threshold. In certain aspects, the configuration is valid during the validity time.

In certain aspects, method 1100 further includes sending a third indication to perform the communication link modification.

In certain aspects, method 1100 further includes performing the communication link modification for a target communication link based on the first prediction.

In certain aspects, method 1100 further includes obtaining feedback associated with the communication link modification, wherein the feedback indicates the target communication link is based on the first prediction.

In certain aspects, the feedback comprises one or more of: an indication of a radio link failure for at least one candidate communication link of the one or more candidate communication links; an indication of a beam failure for the at least one candidate communication link; cell group failure information for the at least one candidate communication link; a handover report for the at least one candidate communication link; or a serving cell report for the at least one candidate communication link. In certain aspects, the feedback comprises a second prediction of at least one candidate communication link.

In certain aspects, method 1100 further includes sending a configuration for communications via at least one candidate communication link of the one or more candidate communication links, wherein the configuration indicates a first set of criteria that trigger application of the configuration and indicates a second set of criteria for selection of one or more parameters of the configuration. In certain aspects, method 1100 further includes communicating via the at least one candidate communication link based on the configuration. In certain aspects, the first set of criteria comprises one or more of: a first criteria that a current time satisfies a threshold; a second criteria that a trajectory of the UE matches an expected trajectory; or a third criteria that a position of the UE matches an expected position. In certain aspects, the second set of criteria comprises one or more of: a first criteria that a velocity of the UE satisfies a first threshold; or a second criteria that a current time is within a time interval of a set of time intervals. In certain aspects, the configuration comprises one or more of: a first configuration for radio link monitoring; a second configuration for beam failure detection; a third configuration for random access communications; or a fourth configuration for channel measurement. In certain aspects, the one or more parameters comprises a set of reference signals for channel measurement and reporting.

In certain aspects, method 1100 further includes providing input data to a ML model. In certain aspects, method 1100 further includes obtaining, from the ML model, output data comprising the first prediction of the one or more candidate communication links.

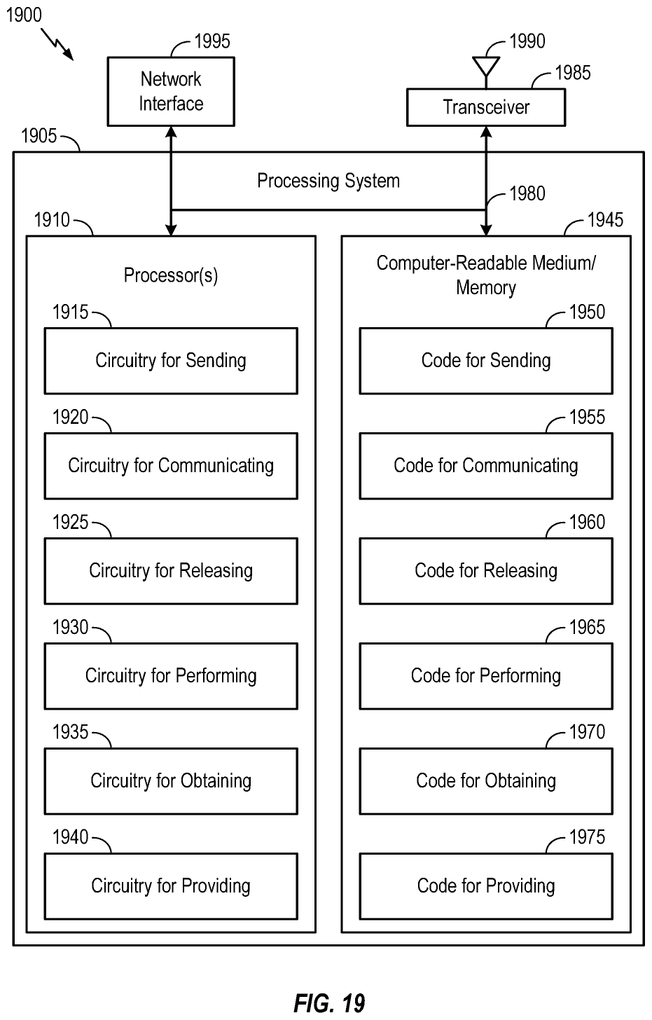

In certain aspects, method 1100, or any aspect related to it, may be performed by an apparatus, such as communications device 1900 of FIG. 19, which includes various components operable, configured, or adapted to perform the method 1100. Communications device 1900 is described below in further detail.

Note that FIG. 11 is just one example of a method, and other methods including fewer, additional, or alternative operations are possible consistent with this disclosure.

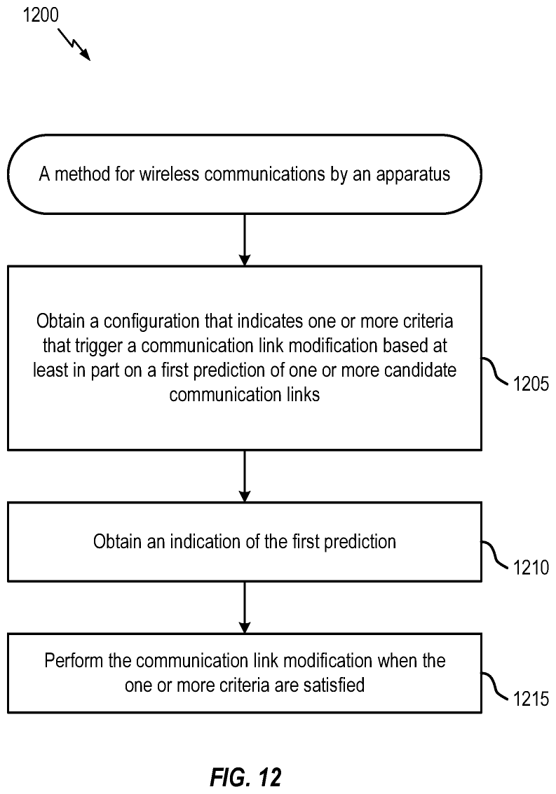

FIG. 12 shows a method 1200 for wireless communications by an apparatus, such as UE 104 of FIGS. 1 and 3.

Method 1200 begins at block 1205 with obtaining a configuration that indicates one or more criteria that trigger a communication link modification based at least in part on a first prediction of one or more candidate communication links. In certain aspects, the one or more criteria comprise one or more of: a first criteria that a probability of encountering at least one candidate communication link of the one or more candidate communication links satisfies a first threshold; a second criteria that a difference between a current time and an expected arrival time for the at least one candidate communication link satisfies a second threshold; or a third criteria that a duration of suitability for the at least one candidate communication link satisfies a third threshold.

Method 1200 then proceeds to block 1210 with obtaining an indication of the first prediction.

Method 1200 then proceeds to block 1215 with performing the communication link modification when the one or more criteria are satisfied.

In certain aspects, method 1200 further includes determining a second prediction, wherein the one or more criteria are satisfied when the second prediction satisfies a threshold. In certain aspects, the second prediction comprises one or more of: a probability of encountering at least one candidate communication link of the one or more candidate communication links; an expected arrival time of encountering the at least one candidate communication link; or a duration of suitability for the at least one candidate communication link, wherein the duration of suitability indicates a time period during which the at least one candidate communication link is expected to be suitable for communications.

In certain aspects, determining the second prediction comprises: providing input data to a ML model; and obtaining, from the ML model, output data comprising the second prediction.

In certain aspects, the communication link modification comprises one or more of: a beam switch; a conditional handover; lower-layered triggered mobility; a serving cell change; a serving cell addition; or a serving cell release.

In certain aspects, the one or more candidate communication links comprises one or more of: one or more cell groups; a first set of candidate cells; or a second set of candidate beams.

In certain aspects, method 1200, or any aspect related to it, may be performed by an apparatus, such as communications device 1800 of FIG. 18, which includes various components operable, configured, or adapted to perform the method 1200. Communications device 1800 is described below in further detail.

Note that FIG. 12 is just one example of a method, and other methods including fewer, additional, or alternative operations are possible consistent with this disclosure.

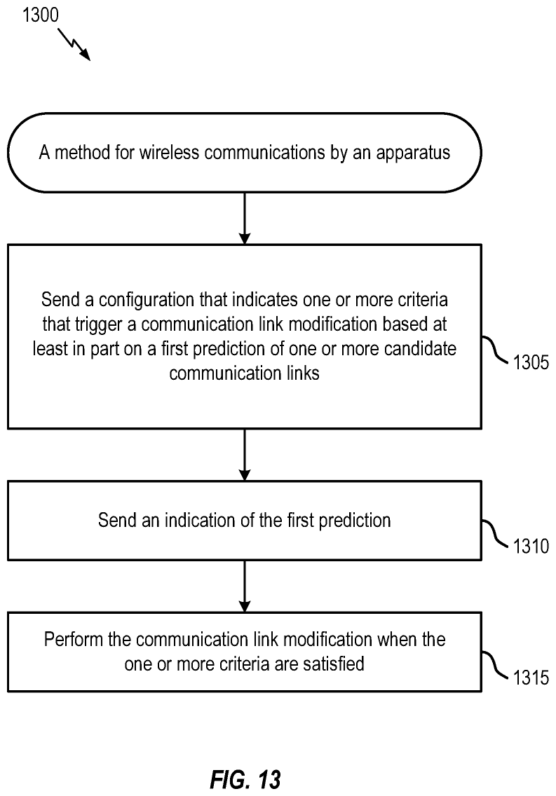

FIG. 13 shows a method 1300 for wireless communications by an apparatus, such as BS 102 of FIGS. 1 and 3, or a disaggregated base station as discussed with respect to FIG. 2.

Method 1300 begins at block 1305 with sending a configuration that indicates one or more criteria that trigger a communication link modification based at least in part on a first prediction of one or more candidate communication links. In certain aspects, the one or more criteria comprise one or more of: a first criteria that a probability of encountering at least one candidate communication link of the one or more candidate communication links satisfies a first threshold; a second criteria that a difference between a current time and an expected arrival time for the at least one candidate communication link satisfies a second threshold; or a third criteria that a duration of suitability for the at least one candidate communication link satisfies a third threshold.

Method 1300 then proceeds to block 1310 with sending an indication of the first prediction.

Method 1300 then proceeds to block 1315 with performing the communication link modification when the one or more criteria are satisfied.

In certain aspects, the one or more criteria are satisfied when a second prediction satisfies a threshold. In certain aspects, the second prediction comprises one or more of: a probability of encountering at least one candidate communication link of the one or more candidate communication links; an expected arrival time of encountering the at least one candidate communication link; or a duration of suitability for the at least one candidate communication link, wherein the duration of suitability indicates a time period during which the at least one candidate communication link is expected to be suitable for communications.

In certain aspects, the communication link modification comprises one or more of: a beam switch; a conditional handover; lower-layered triggered mobility; a serving cell change; a serving cell addition; or a serving cell release.

In certain aspects, the one or more candidate communication links comprises one or more of: one or more cell groups; a first set of candidate cells; or a second set of candidate beams.

In certain aspects, method 1300, or any aspect related to it, may be performed by an apparatus, such as communications device 1900 of FIG. 19, which includes various components operable, configured, or adapted to perform the method 1300. Communications device 1900 is described below in further detail.

Note that FIG. 13 is just one example of a method, and other methods including fewer, additional, or alternative operations are possible consistent with this disclosure.

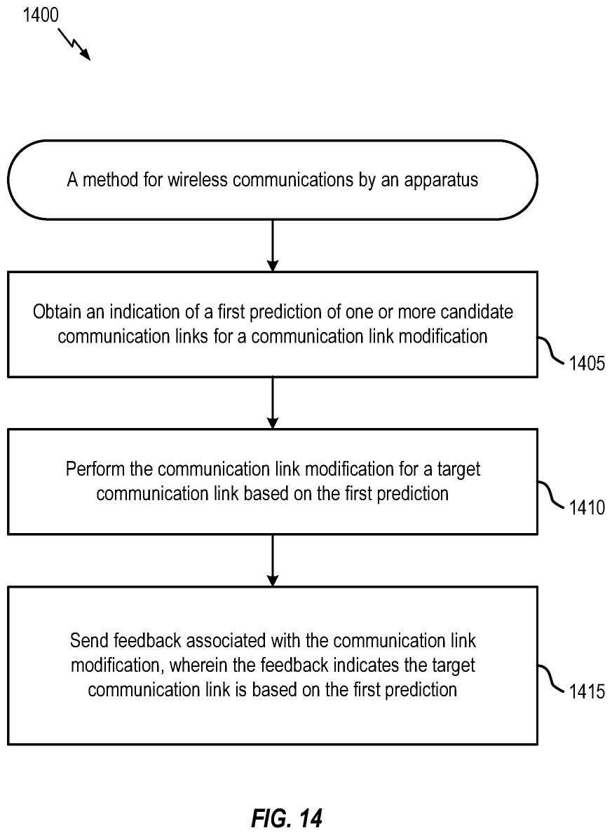

FIG. 14 shows a method 1400 for wireless communications by an apparatus, such as UE 104 of FIGS. 1 and 3.

Method 1400 begins at block 1405 with obtaining an indication of a first prediction of one or more candidate communication links for a communication link modification.

Method 1400 then proceeds to block 1410 with performing the communication link modification for a target communication link based on the first prediction. In certain aspects, the communication link modification comprises one or more of: a beam switch; a conditional handover; lower-layered triggered mobility; a serving cell change; a serving cell addition; or a serving cell release. In certain aspects, the one or more candidate communication links comprises one or more of: one or more cell groups; a first set of candidate cells; or a second set of candidate beams.

Method 1400 then proceeds to block 1415 with sending feedback associated with the communication link modification, wherein the feedback indicates the target communication link is based on the first prediction. In certain aspects, the feedback comprises one or more of: an indication of a radio link failure for at least one candidate communication link of the one or more candidate communication links; an indication of a beam failure for the at least one candidate communication link; cell group failure information for the at least one candidate communication link; a handover report for the at least one candidate communication link; or a serving cell report for the at least one candidate communication link. In certain aspects, method 1400 further includes determining a second prediction of at least one candidate communication link, wherein the feedback comprises the second prediction.

In certain aspects, method 1400, or any aspect related to it, may be performed by an apparatus, such as communications device 1800 of FIG. 18, which includes various components operable, configured, or adapted to perform the method 1400. Communications device 1800 is described below in further detail.

Note that FIG. 14 is just one example of a method, and other methods including fewer, additional, or alternative operations are possible consistent with this disclosure.

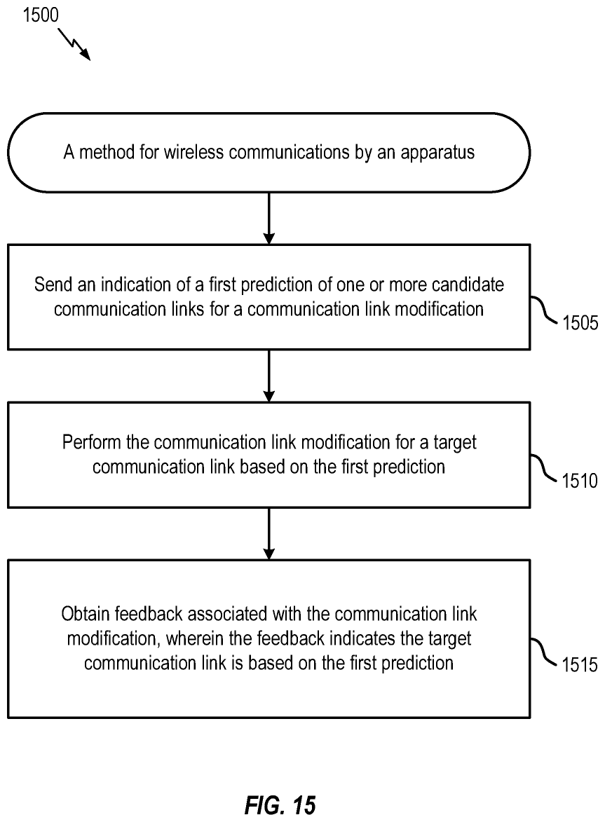

FIG. 15 shows a method 1500 for wireless communications by an apparatus, such as BS 102 of FIGS. 1 and 3, or a disaggregated base station as discussed with respect to FIG. 2.

Method 1500 begins at block 1505 with sending an indication of a first prediction of one or more candidate communication links for a communication link modification. In certain aspects, the one or more candidate communication links comprises one or more of: one or more cell groups; a first set of candidate cells; or a second set of candidate beams. In certain aspects, the communication link modification comprises one or more of: a beam switch; a conditional handover; lower-layered triggered mobility; a serving cell change; a serving cell addition; or a serving cell release.

Method 1500 then proceeds to block 1510 with performing the communication link modification for a target communication link based on the first prediction.

Method 1500 then proceeds to block 1515 with obtaining feedback associated with the communication link modification, wherein the feedback indicates the target communication link is based on the first prediction. In certain aspects, the feedback comprises one or more of: an indication of a radio link failure for at least one candidate communication link of the one or more candidate communication links; an indication of a beam failure for the at least one candidate communication link; cell group failure information for the at least one candidate communication link; a handover report for the at least one candidate communication link; or a serving cell report for the at least one candidate communication link. In certain aspects, the feedback comprises a second prediction of at least one candidate communication link.

In certain aspects, method 1500, or any aspect related to it, may be performed by an apparatus, such as communications device 1900 of FIG. 19, which includes various components operable, configured, or adapted to perform the method 1500. Communications device 1900 is described below in further detail.

Note that FIG. 15 is just one example of a method, and other methods including fewer, additional, or alternative operations are possible consistent with this disclosure.

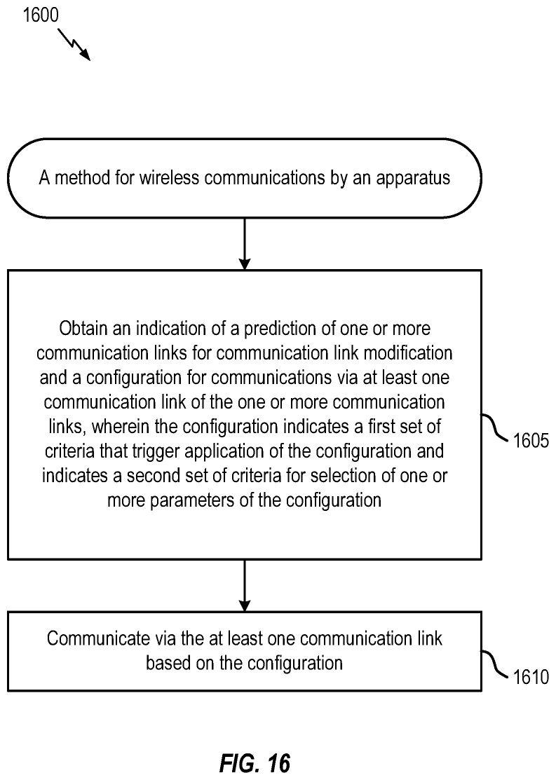

FIG. 16 shows a method 1600 for wireless communications by an apparatus, such as UE 104 of FIGS. 1 and 3.

Method 1600 begins at block 1605 with obtaining an indication of a prediction of one or more communication links for communication link modification and a configuration for communications via at least one communication link of the one or more communication links, wherein the configuration indicates a first set of criteria that trigger application of the configuration and indicates a second set of criteria for selection of one or more parameters of the configuration. In certain aspects, the first set of criteria comprises one or more of: a first criteria that a current time satisfies a threshold; a second criteria that a trajectory of the apparatus matches an expected trajectory; or a third criteria that a position of the apparatus matches an expected position. In certain aspects, the second set of criteria comprises one or more of: a first criteria that a velocity of the apparatus satisfies a first threshold; or a second criteria that a current time is within a time interval of a set of time intervals.

Method 1600 then proceeds to block 1610 with communicating via the at least one communication link based on the configuration.

In certain aspects, the configuration comprises one or more of: a first configuration for radio link monitoring; a second configuration for beam failure detection; a third configuration for random access communications; or a fourth configuration for channel measurement.

In certain aspects, the one or more communication links comprise one or more of: one or more cell groups; a first set of cells; or a second set of beams.

In certain aspects, the one or more parameters comprises a set of reference signals for channel measurement and/or reporting.

In certain aspects, method 1600, or any aspect related to it, may be performed by an apparatus, such as communications device 1800 of FIG. 18, which includes various components operable, configured, or adapted to perform the method 1600. Communications device 1800 is described below in further detail.

Note that FIG. 16 is just one example of a method, and other methods including fewer, additional, or alternative operations are possible consistent with this disclosure.

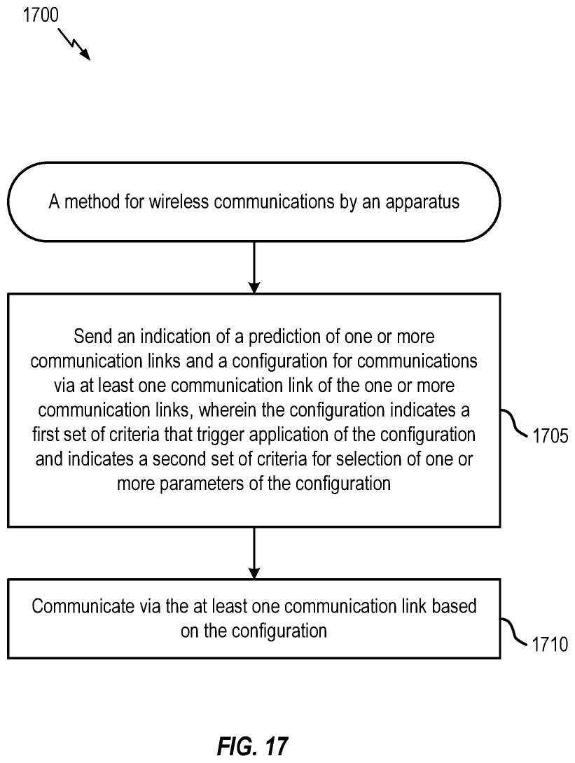

FIG. 17 shows a method 1700 for wireless communications by an apparatus, such as BS 102 of FIGS. 1 and 3, or a disaggregated base station as discussed with respect to FIG. 2.

Method 1700 begins at block 1705 with sending an indication of a prediction of one or more communication links and a configuration for communications via at least one communication link of the one or more communication links, wherein the configuration indicates a first set of criteria that trigger application of the configuration and indicates a second set of criteria for selection of one or more parameters of the configuration. In certain aspects, the first set of criteria comprises one or more of: a first criteria that a current time satisfies a threshold; a second criteria that a trajectory of a UE matches an expected trajectory; or a third criteria that a position of the UE matches an expected position. In certain aspects, the second set of criteria comprises one or more of: a first criteria that a velocity of the UE satisfies a first threshold; or a second criteria that a current time is within a time interval of a set of time intervals.

Method 1700 then proceeds to block 1710 with communicating via the at least one communication link based on the configuration. In certain aspects, the configuration comprises one or more of: a first configuration for radio link monitoring; a second configuration for beam failure detection; a third configuration for random access communications; or a fourth configuration for channel measurement.

In certain aspects, the one or more communication links comprise one or more of: one or more cell groups; a first set of cells; or a second set of beams.

In certain aspects, the one or more parameters comprises a set of reference signals for channel measurement and/or reporting.

In certain aspects, method 1700 further includes sending the configuration to a network entity that communicates via the at least one communication link.

In certain aspects, method 1700 further includes obtaining, from the network entity, a request for a modification to the configuration.

In certain aspects, method 1700, or any aspect related to it, may be performed by an apparatus, such as communications device 1900 of FIG. 19, which includes various components operable, configured, or adapted to perform the method 1700. Communications device 1900 is described below in further detail.

Note that FIG. 17 is just one example of a method, and other methods including fewer, additional, or alternative operations are possible consistent with this disclosure.

### Example Communications Devices

FIG. 18 depicts aspects of an example communications device 1800. In some aspects, communications device 1800 is a user equipment, such as UE 104 described above with respect to FIGS. 1 and 3.

The communications device 1800 includes a processing system 1802 coupled to a transceiver 1838 (e.g., a transmitter and/or a receiver). The transceiver 1838 is configured to transmit and receive signals for the communications device 1800 via an antenna 1840, such as the various signals as described herein. The processing system 1802 may be configured to perform processing functions for the communications device 1800, including processing signals received and/or to be transmitted by the communications device 1800.

The processing system 1802 includes one or more processors 1804. In various aspects, the one or more processors 1804 may be representative of one or more of receive processor 358, transmit processor 364, TX MIMO processor 366, and/or controller/processor 380, as described with respect to FIG. 3. The one or more processors 1804 are coupled to a computer-readable medium/memory 1820 via a bus 1836. In certain aspects, the computer-readable medium/memory 1820 is configured to store instructions (e.g., computer-executable code) that when executed by the one or more processors 1804, enable and cause the one or more processors 1804 to perform the method 1000 described with respect to FIG. 10, or any aspect related to it, including any operations described in relation to FIG. 10; the method 1200 described with respect to FIG. 12, or any aspect related to it, including any operations described in relation to FIG. 12; the method 1400 described with respect to FIG. 14, or any aspect related to it, including any operations described in relation to FIG. 14; and the method 1600 described with respect to FIG. 16, or any aspect related to it, including any operations described in relation to FIG. 16. Note that reference to a processor performing a function of communications device 1800 may include one or more processors performing that function of communications device 1800, such as in a distributed fashion.

In the depicted example, computer-readable medium/memory 1820 stores code for obtaining 1822, code for communicating 1824, code for releasing 1826, code for performing 1828, code for sending 1830, code for determining 1832, and code for providing 1834. Processing of the code 1822-1834 may enable and cause the communications device 1800 to perform the method 1000 described with respect to FIG. 10, or any aspect related to it; the method 1200 described with respect to FIG. 12, or any aspect related to it; the method 1400 described with respect to FIG. 14, or any aspect related to it; and the method 1600 described with respect to FIG. 16, or any aspect related to it.

The one or more processors 1804 include circuitry configured to implement (e.g., execute) the code stored in the computer-readable medium/memory 1820, including circuitry for obtaining 1806, circuitry for communicating 1808, circuitry for releasing 1810, circuitry for performing 1812, circuitry for sending 1814, circuitry for determining 1816, and circuitry for providing 1818. Processing with circuitry 1806-1818 may enable and cause the communications device 1800 to perform the method 1000 described with respect to FIG. 10, or any aspect related to it; the method 1200 described with respect to FIG. 12, or any aspect related to it; the method 1400 described with respect to FIG. 14, or any aspect related to it; and the method 1600 described with respect to FIG. 16, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1838 and/or antenna 1840 of the communications device 1800 in FIG. 18, and/or one or more processors 1804 of the communications device 1800 in FIG. 18. Means for communicating, receiving or obtaining may include the transceivers 354, antenna(s) 352, receive processor 358, AI processor 370, and/or controller/processor 380 of the UE 104 illustrated in FIG. 3, transceiver 1838 and/or antenna 1840 of the communications device 1800 in FIG. 18, and/or one or more processors 1804 of the communications device 1800 in FIG. 18. Means for releasing, performing, and/or determining may include the AI processor 370, and/or controller/processor 380 of the UE 104 illustrated in FIG. 3, and/or one or more processors 1804 of the communications device 1800 in FIG. 18.

FIG. 19 depicts aspects of an example communications device 1900. In some aspects, communications device 1900 is a network entity, such as BS 102 of FIGS. 1 and 3, or a disaggregated base station as discussed with respect to FIG. 2.

The communications device 1900 includes a processing system 1905 coupled to a transceiver 1985 (e.g., a transmitter and/or a receiver) and/or a network interface 1995. The transceiver 1985 is configured to transmit and receive signals for the communications device 1900 via an antenna 1990, such as the various signals as described herein. The network interface 1995 is configured to obtain and send signals for the communications device 1900 via communications link(s), such as a backhaul link, midhaul link, and/or fronthaul link as described herein, such as with respect to FIG. 2. The processing system 1905 may be configured to perform processing functions for the communications device 1900, including processing signals received and/or to be transmitted by the communications device 1900.

The processing system 1905 includes one or more processors 1910. In various aspects, one or more processors 1910 may be representative of one or more of receive processor 338, transmit processor 320, TX MIMO processor 330, and/or controller/processor 340, as described with respect to FIG. 3. The one or more processors 1910 are coupled to a computer-readable medium/memory 1945 via a bus 1980. In certain aspects, the computer-readable medium/memory 1945 is configured to store instructions (e.g., computer-executable code) that when executed by the one or more processors 1910, enable and cause the one or more processors 1910 to perform the method 1100 described with respect to FIG. 11, or any aspect related to it, including any operations described in relation to FIG. 11; the method 1300 described with respect to FIG. 13, or any aspect related to it, including any operations described in relation to FIG. 13; the method 1500 described with respect to FIG. 15, or any aspect related to it, including any operations described in relation to FIG. 15; and the method 1700 described with respect to FIG. 17, or any aspect related to it, including any operations described in relation to FIG. 17. Note that reference to a processor of communications device 1900 performing a function may include one or more processors of communications device 1900 performing that function, such as in a distributed fashion.

In the depicted example, the computer-readable medium/memory 1945 stores code for sending 1950, code for communicating 1955, code for releasing 1960, code for performing 1965, code for obtaining 1970, and code for providing 1975. Processing of the code 1950-1975 may enable and cause the communications device 1900 to perform the method 1100 described with respect to FIG. 11, or any aspect related to it; the method 1300 described with respect to FIG. 13, or any aspect related to it; the method 1500 described with respect to FIG. 15, or any aspect related to it; and the method 1700 described with respect to FIG. 17, or any aspect related to it.

The one or more processors 1910 include circuitry configured to implement (e.g., execute) the code stored in the computer-readable medium/memory 1945, including circuitry for sending 1915, circuitry for communicating 1920, circuitry for releasing 1925, circuitry for performing 1930, circuitry for obtaining 1935, and circuitry for providing 1940. Processing with circuitry 1915-1940 may enable and cause the communications device 1900 to perform the method 1100 described with respect to FIG. 11, or any aspect related to it; the method 1300 described with respect to FIG. 13, or any aspect related to it; the method 1500 described with respect to FIG. 15, or any aspect related to it; and the method 1700 described with respect to FIG. 17, or any aspect related to it.

More generally, means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1985, antenna 1990, and/or network interface 1995 of the communications device 1900 in FIG. 19, and/or one or more processors 1910 of the communications device 1900 in FIG. 19. Means for communicating, receiving or obtaining may include the transceivers 332, antenna(s) 334, receive processor 338, AI processor 318, and/or controller/processor 340 of the BS 102 illustrated in FIG. 3, transceiver 1985, antenna 1990, and/or network interface 1995 of the communications device 1900 in FIG. 19, and/or one or more processors 1910 of the communications device 1900 in FIG. 19. Means for releasing, and/or performing may include the AI processor 318, and/or controller/processor 340 of the BS 102 illustrated in FIG. 3, and/or one or more processors 1910 of the communications device 1900 in FIG. 19.

### EXAMPLE CLAUSES

Implementation examples are described in the following numbered clauses:

Clause 1: A method for wireless communications by an apparatus comprising: obtaining a first indication of a first prediction of one or more candidate communication links for a communication link modification, and a second indication of a validity time associated with the first prediction, wherein the validity time indicates a time period during which the first prediction is valid; and communicating with a network entity based at least in part on the first prediction during the validity time.

Clause 2: The method of Clause 1, wherein the one or more candidate communication links comprises one or more of: one or more cell groups; a first set of candidate cells; or a second set of candidate beams.

Clause 3: The method of any one of Clauses 1-2, wherein communicating with the network entity comprises switching from communicating via a source communication link to a target communication link, the target communication link selected among the one or more candidate communication links.

Clause 4: The method of any one of Clauses 1-3, further comprising obtaining a configuration that indicates one or more criteria that trigger the communication link modification based on the first prediction.

Clause 5: The method of Clause 4, wherein the communication link modification comprises one or more of: a beam switch; a conditional handover; lower-layered triggered mobility; a serving cell change; a serving cell addition; or a serving cell release.

Clause 6: The method of Clause 4 or 5, wherein the one or more criteria comprise one or more of: a first criteria that a probability of encountering at least one candidate communication link of the one or more candidate communication links satisfies a first threshold; a second criteria that a difference between a current time and an expected arrival time for the at least one candidate communication link satisfies a second threshold; or a third criteria that a duration of suitability for the at least one candidate communication link satisfies a third threshold.

Clause 7: The method of any one of Clauses 4,-6 wherein the configuration is valid during the validity time.

Clause 8: The method of any one of Clauses 4-7, wherein the second indication of the validity time comprises a validity timer that starts running when the first prediction is communicated.

Clause 9: The method of Clause 8, further comprising releasing the configuration upon expiration of the validity timer.

Clause 10: The method of any one of Clauses 1-9, further comprising obtaining a third indication to perform the communication link modification.

Clause 11: The method of any one of Clauses 1-10, further comprising: performing the communication link modification for a target communication link based on the first prediction; and sending feedback associated with the communication link modification, wherein the feedback indicates the target communication link is based on the first prediction.

Clause 12: The method of Clause 11, wherein the feedback comprises one or more of: an indication of a radio link failure for at least one candidate communication link of the one or more candidate communication links; an indication of a beam failure for the at least one candidate communication link; cell group failure information for the at least one candidate communication link; a handover report for the at least one candidate communication link; or a serving cell report for the at least one candidate communication link.

Clause 13: The method of Clause 11 or 12, further comprising determining a second prediction of at least one candidate communication link, wherein the feedback comprises the second prediction.

Clause 14: The method of any one of Clauses 1-13, further comprising: obtaining a configuration for communications via at least one candidate communication link of the one or more candidate communication links, wherein the configuration indicates a first set of criteria that trigger application of the configuration and indicates a second set of criteria for selection of one or more parameters of the configuration; and communicating via the at least one candidate communication link based on the configuration.

Clause 15: The method of Clause 14, wherein the first set of criteria comprises one or more of: a first criteria that a current time satisfies a threshold; a second criteria that a trajectory of the apparatus matches an expected trajectory; or a third criteria that a position of the apparatus matches an expected position.

Clause 16: The method of Clause 14 or 15, wherein the second set of criteria comprises one or more of: a first criteria that a velocity of the apparatus satisfies a first threshold; or a second criteria that a current time is within a time interval of a set of time intervals.

Clause 17: The method of any one of Clauses 14-16, wherein the configuration comprises one or more of: a first configuration for radio link monitoring; a second configuration for beam failure detection; a third configuration for random access communications; or a fourth configuration for channel measurement.

Clause 18: The method of any one of Clauses 14-17, wherein the one or more parameters comprises a set of reference signals for channel measurement and reporting.

Clause 19: The method of any one of Clauses 1-18, further comprising: providing input data to a ML model, wherein the input data comprises the first prediction; and obtaining, from the ML model, output data comprising a second prediction of the one or more candidate communication links for the communication link modification; and communicating with the network entity comprises communicating with the network entity further based at least in part on the second prediction.

Clause 20: A method for wireless communications by an apparatus comprising: sending a first indication of a first prediction of one or more candidate communication links for a communication link modification, and a second indication of a validity time associated with the first prediction, wherein the validity time indicates a time period during which the first prediction is valid; and communicating with a UE based at least in part on the first prediction during the validity time.

Clause 21: The method of Clause 20, wherein the one or more candidate communication links comprises one or more of: one or more cell groups; a first set of candidate cells; or a second set of candidate beams.

Clause 22: The method of any one of Clauses 20-21, wherein communicating with the UE comprises switching from communicating via a source communication link to a target communication link, the target communication link selected among the one or more candidate communication links.

Clause 23: The method of any one of Clauses 20-22, further comprising sending a configuration that indicates one or more criteria that trigger the communication link modification based on the first prediction.

Clause 24: The method of Clause 23, wherein the communication link modification comprises one or more of: a beam switch; a conditional handover; lower-layered triggered mobility; a serving cell change; a serving cell addition; or a serving cell release.

Clause 25: The method of Clause 23 or 24, wherein the one or more criteria comprise one or more of: a first criteria that a probability of encountering at least one candidate communication link of the one or more candidate communication links satisfies a first threshold; a second criteria that a difference between a current time and an expected arrival time for the at least one candidate communication link satisfies a second threshold; or a third criteria that a duration of suitability for the at least one candidate communication link satisfies a third threshold.

Clause 26: The method of any one of Clauses 23-25, wherein the configuration is valid during the validity time.

Clause 27: The method of any one of Clauses 23-26, wherein the second indication of the validity time comprises a validity timer that starts running when the first prediction is communicated.

Clause 28: The method of Clause 27, further comprising releasing the configuration upon expiration of the validity timer.

Clause 29: The method of any one of Clauses 20-28, further comprising sending a third indication to perform the communication link modification.

Clause 30: The method of any one of Clauses 20-29, further comprising: performing the communication link modification for a target communication link based on the first prediction; and obtaining feedback associated with the communication link modification, wherein the feedback indicates the target communication link is based on the first prediction.

Clause 31: The method of Clause 30, wherein the feedback comprises one or more of: an indication of a radio link failure for at least one candidate communication link of the one or more candidate communication links; an indication of a beam failure for the at least one candidate communication link; cell group failure information for the at least one candidate communication link; a handover report for the at least one candidate communication link; or a serving cell report for the at least one candidate communication link.

Clause 32: The method of Clause 30 or 31, wherein the feedback comprises a second prediction of at least one candidate communication link.

Clause 33: The method of any one of Clauses 20-32, further comprising: sending a configuration for communications via at least one candidate communication link of the one or more candidate communication links, wherein the configuration indicates a first set of criteria that trigger application of the configuration and indicates a second set of criteria for selection of one or more parameters of the configuration; and communicating via the at least one candidate communication link based on the configuration.

Clause 34: The method of Clause 33, wherein the first set of criteria comprises one or more of: a first criteria that a current time satisfies a threshold; a second criteria that a trajectory of the UE matches an expected trajectory; or a third criteria that a position of the UE matches an expected position.

Clause 35: The method of Clause 33 or 34, wherein the second set of criteria comprises one or more of: a first criteria that a velocity of the UE satisfies a first threshold; or a second criteria that a current time is within a time interval of a set of time intervals.

Clause 36: The method of any one of Clauses 33-35, wherein the configuration comprises one or more of: a first configuration for radio link monitoring; a second configuration for beam failure detection; a third configuration for random access communications; or a fourth configuration for channel measurement.

Clause 37: The method of any one of Clauses 33-36, wherein the one or more parameters comprises a set of reference signals for channel measurement and reporting.

Clause 38: The method of any one of Clauses 20-37, further comprising: providing input data to a ML model; and obtaining, from the ML model, output data comprising the first prediction of the one or more candidate communication links.

Clause 39: A method for wireless communications by an apparatus comprising: obtaining a configuration that indicates one or more criteria that trigger a communication link modification based at least in part on a first prediction of one or more candidate communication links; obtaining an indication of the first prediction; and performing the communication link modification when the one or more criteria are satisfied.

Clause 40: The method of Clause 39, wherein the one or more criteria comprise one or more of: a first criteria that a probability of encountering at least one candidate communication link of the one or more candidate communication links satisfies a first threshold; a second criteria that a difference between a current time and an expected arrival time for the at least one candidate communication link satisfies a second threshold; or a third criteria that a duration of suitability for the at least one candidate communication link satisfies a third threshold.

Clause 41: The method of any one of Clauses 39-40, further comprising determining a second prediction, wherein the one or more criteria are satisfied when the second prediction satisfies a threshold.

Clause 42: The method of Clause 41, wherein the second prediction comprises one or more of: a probability of encountering at least one candidate communication link of the one or more candidate communication links; an expected arrival time of encountering the at least one candidate communication link; or a duration of suitability for the at least one candidate communication link, wherein the duration of suitability indicates a time period during which the at least one candidate communication link is expected to be suitable for communications.

Clause 43: The method of Clause 41 or 42, wherein determining the second prediction comprises: providing input data to a ML model; and obtaining, from the ML model, output data comprising the second prediction.

Clause 44: The method of any one of Clauses 39-43, wherein the communication link modification comprises one or more of: a beam switch; a conditional handover; lower-layered triggered mobility; a serving cell change; a serving cell addition; or a serving cell release.

Clause 45: The method of any one of Clauses 39-44, wherein the one or more candidate communication links comprises one or more of: one or more cell groups; a first set of candidate cells; or a second set of candidate beams.

Clause 46: A method for wireless communications by an apparatus comprising: sending a configuration that indicates one or more criteria that trigger a communication link modification based at least in part on a first prediction of one or more candidate communication links; sending an indication of the first prediction; and performing the communication link modification when the one or more criteria are satisfied.

Clause 47: The method of Clause 46, wherein the one or more criteria comprise one or more of: a first criteria that a probability of encountering at least one candidate communication link of the one or more candidate communication links satisfies a first threshold; a second criteria that a difference between a current time and an expected arrival time for the at least one candidate communication link satisfies a second threshold; or a third criteria that a duration of suitability for the at least one candidate communication link satisfies a third threshold.

Clause 48: The method of any one of Clauses 46-47, wherein the one or more criteria are satisfied when a second prediction satisfies a threshold.

Clause 49: The method of Clause 48, wherein the second prediction comprises one or more of: a probability of encountering at least one candidate communication link of the one or more candidate communication links; an expected arrival time of encountering the at least one candidate communication link; or a duration of suitability for the at least one candidate communication link, wherein the duration of suitability indicates a time period during which the at least one candidate communication link is expected to be suitable for communications.

Clause 50: The method of any one of Clauses 46-49, wherein the communication link modification comprises one or more of: a beam switch; a conditional handover; lower-layered triggered mobility; a serving cell change; a serving cell addition; or a serving cell release.

Clause 51: The method of any one of Clauses 46-50, wherein the one or more candidate communication links comprises one or more of: one or more cell groups; a first set of candidate cells; or a second set of candidate beams.

Clause 52: A method for wireless communications by an apparatus comprising: obtaining an indication of a first prediction of one or more candidate communication links for a communication link modification; performing the communication link modification for a target communication link based on the first prediction; and sending feedback associated with the communication link modification, wherein the feedback indicates the target communication link is based on the first prediction.

Clause 53: The method of Clause 52, wherein the feedback comprises one or more of: an indication of a radio link failure for at least one candidate communication link of the one or more candidate communication links; an indication of a beam failure for the at least one candidate communication link; cell group failure information for the at least one candidate communication link; a handover report for the at least one candidate communication link; or a serving cell report for the at least one candidate communication link.

Clause 54: The method of any one of Clauses 52-53, further comprising determining a second prediction of at least one candidate communication link, wherein the feedback comprises the second prediction.

Clause 55: The method of any one of Clauses 52-54, wherein the communication link modification comprises one or more of: a beam switch; a conditional handover; lower-layered triggered mobility; a serving cell change; a serving cell addition; or a serving cell release.

Clause 56: The method of any one of Clauses 52-55, wherein the one or more candidate communication links comprises one or more of: one or more cell groups; a first set of candidate cells; or a second set of candidate beams.

Clause 57: A method for wireless communications by an apparatus comprising: sending an indication of a first prediction of one or more candidate communication links for a communication link modification; performing the communication link modification for a target communication link based on the first prediction; and obtaining feedback associated with the communication link modification, wherein the feedback indicates the target communication link is based on the first prediction.

Clause 58: The method of Clause 57, wherein the feedback comprises one or more of: an indication of a radio link failure for at least one candidate communication link of the one or more candidate communication links; an indication of a beam failure for the at least one candidate communication link; cell group failure information for the at least one candidate communication link; a handover report for the at least one candidate communication link; or a serving cell report for the at least one candidate communication link.

Clause 59: The method of any one of Clauses 57-58, wherein the feedback comprises a second prediction of at least one candidate communication link.

Clause 60: The method of any one of Clauses 57-59, wherein the communication link modification comprises one or more of: a beam switch; a conditional handover; lower-layered triggered mobility; a serving cell change; a serving cell addition; or a serving cell release.

Clause 61: The method of any one of Clauses 57-60, wherein the one or more candidate communication links comprises one or more of: one or more cell groups; a first set of candidate cells; or a second set of candidate beams.

Clause 62: A method for wireless communications by an apparatus comprising: obtaining an indication of a prediction of one or more communication links for communication link modification and a configuration for communications via at least one communication link of the one or more communication links, wherein the configuration indicates a first set of criteria that trigger application of the configuration and indicates a second set of criteria for selection of one or more parameters of the configuration; and communicating via the at least one communication link based on the configuration.

Clause 63: The method of Clause 62, wherein the first set of criteria comprises one or more of: a first criteria that a current time satisfies a threshold; a second criteria that a trajectory of the apparatus matches an expected trajectory; or a third criteria that a position of the apparatus matches an expected position.

Clause 64: The method of any one of Clauses 62-63, wherein the second set of criteria comprises one or more of: a first criteria that a velocity of the apparatus satisfies a first threshold; or a second criteria that a current time is within a time interval of a set of time intervals.

Clause 65: The method of any one of Clauses 62-64, wherein the configuration comprises one or more of: a first configuration for radio link monitoring; a second configuration for beam failure detection; a third configuration for random access communications; or a fourth configuration for channel measurement.

Clause 66: The method of any one of Clauses 62-65, wherein the one or more communication links comprise one or more of: one or more cell groups; a first set of cells; or a second set of beams.

Clause 67: The method of any one of Clauses 62-66, wherein the one or more parameters comprises a set of reference signals for channel measurement and reporting.

Clause 68: A method for wireless communications by an apparatus comprising: sending an indication of a prediction of one or more communication links and a configuration for communications via at least one communication link of the one or more communication links, wherein the configuration indicates a first set of criteria that trigger application of the configuration and indicates a second set of criteria for selection of one or more parameters of the configuration; and communicating via the at least one communication link based on the configuration.

Clause 69: The method of Clause 68, wherein the first set of criteria comprises one or more of: a first criteria that a current time satisfies a threshold; a second criteria that a trajectory of a UE matches an expected trajectory; or a third criteria that a position of the UE matches an expected position.

Clause 70: The method of any one of Clauses 68-69, wherein the second set of criteria comprises one or more of: a first criteria that a velocity of the UE satisfies a first threshold; or a second criteria that a current time is within a time interval of a set of time intervals.

Clause 71: The method of any one of Clauses 68-70, wherein the configuration comprises one or more of: a first configuration for radio link monitoring; a second configuration for beam failure detection; a third configuration for random access communications; or a fourth configuration for channel measurement.

Clause 72: The method of any one of Clauses 68-71, wherein the one or more communication links comprise one or more of: one or more cell groups; a first set of cells; or a second set of beams.

Clause 73: The method of any one of Clauses 68-72, wherein the one or more parameters comprises a set of reference signals for channel measurement and reporting.

Clause 74: The method of any one of Clauses 68-73, further comprising sending the configuration to a network entity that communicates via the at least one communication link.

Clause 75: The method of Clause 74, further comprising obtaining, from the network entity, a request for a modification to the configuration.

Clause 76: One or more apparatuses, comprising: one or more memories comprising executable instructions; and one or more processors configured to execute the executable instructions and cause the one or more apparatuses to perform a method in accordance with any one of Clauses 1-75.

Clause 77: One or more apparatuses, comprising: one or more memories; and one or more processors, coupled to the one or more memories, configured to cause the one or more apparatuses to perform a method in accordance with any one of Clauses 1-75.

Clause 78: One or more apparatuses, comprising: one or more memories; and one or more processors, coupled to the one or more memories, configured to perform a method in accordance with any one of Clauses 1-75.

Clause 79: One or more apparatuses, comprising means for performing a method in accordance with any one of Clauses 1-75.

Clause 80: One or more non-transitory computer-readable media comprising executable instructions that, when executed by one or more processors of one or more apparatuses, cause the one or more apparatuses to perform a method in accordance with any one of Clauses 1-75.

Clause 81: One or more computer program products embodied on one or more computer-readable storage media comprising code for performing a method in accordance with any one of Clauses 1-75.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause the apparatus to:
obtain a first indication of a first prediction of one or more candidate communication links for a communication link modification, and a second indication of a validity time associated with the first prediction, wherein the validity time indicates a time period during which the first prediction is valid; and
communicate with a network entity based at least in part on the first prediction during the validity time.

2. The apparatus of claim 1, wherein to communicate with the network entity, the one or more processors are configured to cause the apparatus to switch from communicating via a source communication link to a target communication link, the target communication link selected among the one or more candidate communication links.

3. The apparatus of claim 1, wherein the one or more processors are configured to cause the apparatus to obtain a configuration that indicates one or more criteria that trigger the communication link modification based on the first prediction.

4. The apparatus of claim 3, wherein the one or more criteria comprise one or more of:
a first criteria that a probability of encountering at least one candidate communication link of the one or more candidate communication links satisfies a first threshold;
a second criteria that a difference between a current time and an expected arrival time for the at least one candidate communication link satisfies a second threshold; or
a third criteria that a duration of suitability for the at least one candidate communication link satisfies a third threshold.

5. The apparatus of claim 1, wherein the one or more processors are configured to cause the apparatus to:
perform the communication link modification for a target communication link based on the first prediction; and
send feedback associated with the communication link modification, wherein the feedback indicates the target communication link is based on the first prediction.

6. The apparatus of claim 5, wherein the feedback comprises one or more of:
an indication of a radio link failure for at least one candidate communication link of the one or more candidate communication links;
an indication of a beam failure for the at least one candidate communication link;
cell group failure information for the at least one candidate communication link;
a handover report for the at least one candidate communication link; or
a serving cell report for the at least one candidate communication link.

7. The apparatus of claim 5, wherein the one or more processors are configured to cause the apparatus to determine a second prediction of at least one candidate communication link, wherein the feedback comprises the second prediction.

8. The apparatus of claim 1, wherein the one or more processors are configured to cause the apparatus to:
obtain a configuration for communications via at least one candidate communication link of the one or more candidate communication links, wherein the configuration indicates a first set of criteria that trigger application of the configuration and indicates a second set of criteria for selection of one or more parameters of the configuration; and
communicate via the at least one candidate communication link based on the configuration.

9. The apparatus of claim 8, wherein the first set of criteria comprises one or more of:
a first criteria that a current time satisfies a threshold;
a second criteria that a trajectory of the apparatus matches an expected trajectory; or
a third criteria that a position of the apparatus matches an expected position.

10. The apparatus of claim 8, wherein the second set of criteria comprises one or more of:
a first criteria that a velocity of the apparatus satisfies a first threshold; or
a second criteria that a current time is within a time interval of a set of time intervals.

11. The apparatus of claim 1, wherein:
the one or more processors are configured to cause the apparatus to:
provide input data to a machine learning (ML) model, wherein the input data comprises the first prediction; and
obtain, from the ML model, output data comprising a second prediction of the one or more candidate communication links for the communication link modification; and
to communicate with the network entity, the one or more processors are configured to cause the apparatus to communicate with the network entity further based at least in part on the second prediction.

12. An apparatus configured for wireless communications, comprising:
one or more memories; and
one or more processors coupled to the one or more memories, the one or more processors being configured to cause the apparatus to:
send a first indication of a first prediction of one or more candidate communication links for a communication link modification, and a second indication of a validity time associated with the first prediction, wherein the validity time indicates a time period during which the first prediction is valid; and
communicate with a user equipment (UE) based at least in part on the first prediction during the validity time.

13. The apparatus of claim 12, wherein to communicate with the UE, the one or more processors are configured to cause the apparatus to switch from communicating via a source communication link to a target communication link, the target communication link selected among the one or more candidate communication links.

14. The apparatus of claim 12, wherein the one or more processors are configured to cause the apparatus to send a configuration that indicates one or more criteria that trigger the communication link modification based on the first prediction.

15. The apparatus of claim 14, wherein the one or more criteria comprise one or more of:
a first criteria that a probability of encountering at least one candidate communication link of the one or more candidate communication links satisfies a first threshold;
a second criteria that a difference between a current time and an expected arrival time for the at least one candidate communication link satisfies a second threshold; or
a third criteria that a duration of suitability for the at least one candidate communication link satisfies a third threshold.

16. The apparatus of claim 12, wherein the one or more processors are configured to cause the apparatus to:
perform the communication link modification for a target communication link based on the first prediction; and
obtain feedback associated with the communication link modification, wherein the feedback indicates the target communication link is based on the first prediction.

17. The apparatus of claim 16, wherein the feedback comprises a second prediction of at least one candidate communication link.

18. The apparatus of claim 12, wherein the one or more processors are configured to cause the apparatus to:
send a configuration for communications via at least one candidate communication link of the one or more candidate communication links, wherein the configuration indicates a first set of criteria that trigger application of the configuration and indicates a second set of criteria for selection of one or more parameters of the configuration; and
communicate via the at least one candidate communication link based on the configuration.

19. The apparatus of claim 12, wherein the one or more processors are configured to cause the apparatus to:
provide input data to a machine learning (ML) model; and
obtain, from the ML model, output data comprising the first prediction of the one or more candidate communication links.

20. A method for wireless communications by an apparatus comprising:
obtaining a first indication of a first prediction of one or more candidate communication links for a communication link modification, and a second indication of a validity time associated with the first prediction, wherein the validity time indicates a time period during which the first prediction is valid; and
communicating with a network entity based at least in part on the first prediction during the validity time.
